(19) United States
(12) Patent Application Publication
(10) Pub. No.: US 2017/0332469 A1
(43) Pub. Date: Nov. 16, 2017

(54) PLASMA CUTTING TORCH ASSEMBLY AND USE OF WEAR PARTS IN A PLASMA CUTTING TORCH ASSEMBLY

(71) Applicant: KJELLBERG-STIFTUNG, Finsterwalde (DE)

(72) Inventors: Bach Friedrich-Wilhelm, Finsterwalde (DE); HASSEL Thomas, Hannover (DE); LAURISCH Frank, Finsterwalde (DE); GRUNDKE Timo, Finsterwalde (DE); REINKE Ralf-Peter, Finsterwalde (DE); KRINK Volker, Finsterwalde (DE)

(73) Assignee: KJELLBERG-STIFTUNG, Finsterwalde (DE)

(21) Appl. No.: 15/330,797

(22) PCT Filed: May 5, 2015
(86) PCT No.: PCT/EP2015/059841

§ 371 Date: Nov. 7, 2016

(30) Foreign Application Priority Data
May 7, 2014 (EP) 14167330.1

(51) Int. Cl. H05H 1/34; B23K 10/00

(52) U.S. Cl. CPC H05H 1/34; H05H 2001/3478; B23K 10/00; H05H 2001/3463

(57) ABSTRACT

The invention relates to a plasma cutting arrangement having at least one plasma cutting torch which is formed by a torch body, an electrode and a nozzle having a nozzle bore. An outer contour AK of the plasma cutting torch is present in cross-section with respect to a longitudinal axis which is aligned perpendicular through the nozzle bore. A smallest spacing between the longitudinal axis extending through the center of the nozzle bore of the nozzle and the radially outer margin of the outer contour AK is observed in at least one axial direction and corresponds at a maximum to ¾ of the length of a largest spacing d between the central longitudinal axis extending through the center of the nozzle bore of the nozzle and the radial outer margin of the outer contour AK. A smallest spacing c can also correspond to a maximum of ⅜ of the length of a largest distance b between two points of the outer margin of the outer contour AK whose virtual straight connection line extends through the central longitudinal axis extending through the center of the nozzle bore of the nozzle.

The invention relates to a plasma cutting arrangement which can in particular be used for simultaneous plasma cutting using plasma cutting torches and in particular for the simultaneous forming of chamfers at cutting edges or a simultaneous heat treatment. It equally relates to the use of wear parts in the plasma cutting torch arrangement.

Plasma cutting is used for cutting metals. Plasma cutting torches are used for this. In machine cutting, they can be guided by a guide system such as a CNC controlled xy coordinate cutting machine or an industrial robot.

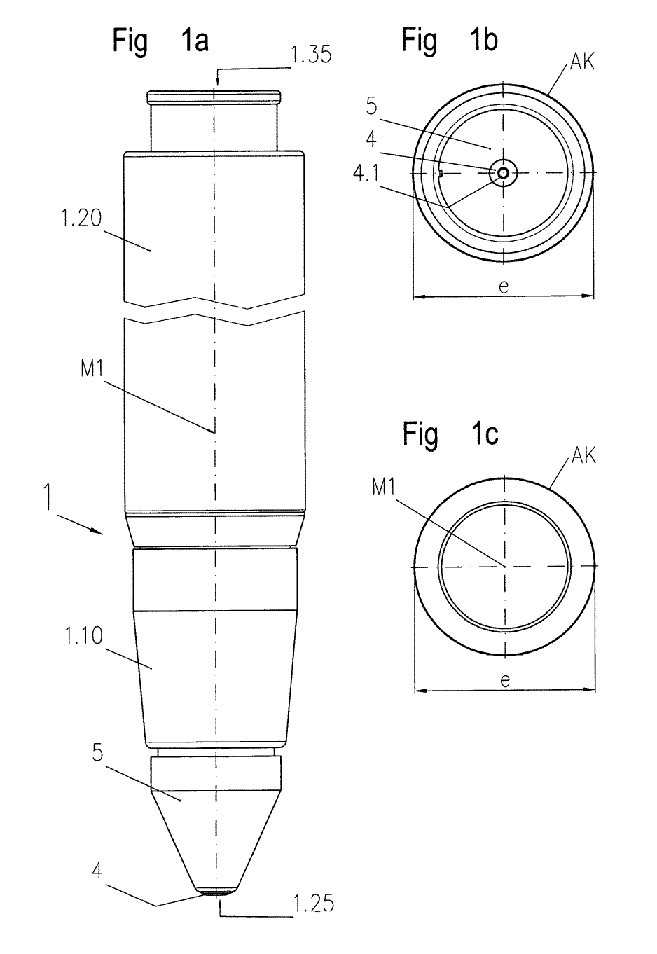

Plasma cutting torches as a rule comprise a torch shaft and a torch head. The connections for the media which are required for operating a plasma cutting torch, e.g. for the gas (plasma gas), the power (cutting power), the cooling (cooling medium, cooling water), the ignition voltage and/or pilot current, are located in the torch shaft. The connections can also be combined, e.g. power and cooling medium in one connection. These connections are connected to hoses which can be combined to form a so-called hose package. Solenoid valves for switching the gases can also be accommodated in the torch shaft. These connections, hoses and components require a volume which determines the size of the plasma torch shaft. Such shafts are typically configured in cylindrical shape with a specific outer diameter, whereby the construction size is determined. Starting from the end or tip of the plasma cutting torch, a circular outer shape is selected in this respect such as can be seen from FIGS. 1a-1c. In this respect, the outer diameter of the circle depends on the cross-sections required for this purpose of the electrical lines for the power and on the cross-sections of the hose lines for gas volume flows and cooling water flows and thus also on the power of the plasma cutting torch. The diameter is in the range between 50 mm to 60 mm with a cutting current range from 200 A to 600 A and with the power range associated therewith of 25 kW to 120 kW.

The described construction shape has disadvantages, in particular when a plurality of plasma cutting torches are to be operated as close as possible next to one another and/or are to be used inclined with respect to one another or to the workpiece surface.

There is also equally a disadvantage when particularly deep cuts, which are deeper than the maximum material thickness which can be cut as a maximum with the plasma cutting torch, are to be introduced into a material.

One application is the cutting of chamfers at metal plates which are required when the metal plates are to be welded after the cutting to shape. There are different chamfer shapes or weld seam preparations (DIN EN ISO 9692-1) for this in dependence on the metal plate thickness and on the welding method. For specific applications (DY seam, Y seam), a plurality of chamfers are required at a metal plate edge. A plurality of plasma cutting torches which are differently inclined with respect to the upper edge of the metal plate can cut and can form chamfers simultaneously here. This is called multi-chamfer cutting. It is also possible to cut individual chamfers after one and other using one and the same plasma cutting torch. The longer cutting time is disadvantageous here since the individual cuts are carried out after one another and the risk is very large that distortion or displacements in the metal plate occur between the cuts and the desired geometry of the component to be cut is no longer reached.

The multi-chamfer cutting is not possible or only incompletely possible with conventional plasma cutting torches. In particular when a plurality of plasma cutting torches are to be arranged close next to one another and/or are to be used inclined with respect to one another or to the workpiece surface.

The smallest spacing between the plasma jets exiting the nozzle which can be realized is then equal to the outer diameter of the plasma torch shaft plus a safety spacing between the plasma torch shafts, which can amount, for example, to 1 to 5 mm, when the plasma cutting torches are to be operated in parallel next to one another.

Plasma cutting torches are known which can be used for cutting chamfers. In this respect, the outer diameter of the torch head tapers in its width over a certain length in the region of the nozzle from which the plasma exits. A pointed construction shape is thus achieved and the formation of chamfer cuts thus becomes possible with limitations. There is, however, the disadvantage due to the cylindrical round shape of the plasma torch shaft having a corresponding outer diameter that a plurality of plasma cutting torches cannot be pivoted past one another with a small spacing. Chamfer angles which are in particular variable can thus not be formed simultaneously using a plurality of plasma torches during one cut. The tips or nozzle bores of the plasma cutting torches directed toward the workpiece to be cut should in this respect, however, be positioned as closely as possible to one another, which is, however, limited by the diameter of the plasma torch shaft on pivot movements of the plasma cutting torches. These disadvantages also occur on the use of a plurality of plasma cutting torches when they are to be used simultaneously and close to one another for different thermal machining processes which are, for example, to be carried out after one another along a kerf to be formed.

It is therefore the object of the invention to improve the conditions and the production precision on the use of a plurality of plasma cutting torches which are to be operated simultaneously and close to one another.

This object is achieved in accordance with the invention by a plasma cutting torch having the features of claim 1. Claim 15 relates to the use of wear parts. Advantageous embodiments and further developments of the invention can be realized using features designated in subordinate claims.

In the plasma cutting torch arrangement in accordance with the invention, at least one plasma cutting torch is present which is formed with a torch body, an electrode and a nozzle having a nozzle bore. In this respect, an outer contour of the plasma cutting torch is present in cross-section with respect to a longitudinal axis which is aligned perpendicular through the nozzle bore and the torch body, in which outer contour a smallest spacing c is observed in at least one axial direction between the longitudinal axis extending through the center of the nozzle bore of the nozzle and the radially outer margin of the outer contour which corresponds to a maximum of ¾ of the length of a largest spacing d between the central longitudinal axis extending through the center of the nozzle bore of the nozzle and radial outer margin of the outer contour AK. A smallest spacing c can, however, also correspond to a maximum of ⅜ of the length of a largest distance b between two points of the outer margin of the outer contour AK whose virtual straight connection line extends through the central longitudinal axis M1, M2, M3 extending through the center of the nozzle bore 4.1 of the nozzle 4.

The outer contour is therefore not rotationally symmetrical with respect to the longitudinal axis extending through the center of the nozzle bore.

In an advantageous embodiment, a smallest spacing c should be observed along a common axis guided in two opposite directions starting from the longitudinal axis extending through the center of the nozzle bore of the nozzle up to the radially outer margin of the outer contour. It is thereby possible to arrange a respective plasma cutting torch at two oppositely disposed sides of a plasma cutting torch formed in this manner very close thereto in simultaneous operation, at the sides at which a smallest spacing is observed.

There is the possibility that at least one smallest spacing c is observed over the total length of a plasma cutting torch or is not exceeded in this respect. In this form, plasma cutting torches can be operated arranged very close next to one another in a parallel arrangement.

A smallest spacing c should, however, be observed or not exceeded at least over the total length of the nozzle, of the nozzle cap, of a nozzle protective cap and, optionally, of a nozzle protective cap holder.

A smallest spacing c can also be observed over a length I which corresponds to at least 1.4 times the maximum width b (largest spacing between two points of the outer margin of the outer contour AK whose virtual straight connection line extends through or intersects the central longitudinal axis M1, M2, M3 extending through the center of the nozzle bore 4.1 of the nozzle 4) of a plasma cutting torch in the region in which a smallest spacing c is observed. A length I can thus have been observed, for example, with a maximum width b of 50 mm (d=25 mm) or a length I of 98 mm with a maximum width b of 70 mm (b=35 mm).

There is the possibility in an embodiment that the center of the nozzle bore is arranged eccentrically within the outer contour. In this case, all the elements or a very large number of elements of the plasma cutting torch, for example the shaft, the nozzle, the nozzle holder, etc., otherwise have a rotationally symmetrical cross-section and a smallest spacing c is nevertheless observed at one side.

It is advantageous if a smallest spacing c is observed of a maximum of ⅓, preferably of a maximum of ¼, and particularly preferably of a maximum of ⅙ of the largest spacing b.

It is advantageous if a smallest spacing c is observed of a maximum of ⅔, preferably of a maximum of ½, and particularly preferably of a maximum of ⅓ of the largest spacing d.

A smallest spacing c can be observed in at least one angular range α of a maximum of 120°, preferably of a maximum of 70°, starting about the longitudinal axis. The peripheral surface at which a smallest spacing c is observed is thereby larger, and plasma torch cutters arranged next to one another and in parallel with one another can thus be arranged and operated closely next to one another.

There is the possibility that the outer contour has at least one largest spacing b directed radially to the nozzle bore, between two points of the outer contour, and its virtual straight connection line intersects the virtual longitudinal axis extending through the center of the nozzle bore of the nozzle, in the angular range rotated between a minimum angle βₘᵢₙ of 60° and the maximum angle βₘₐₓ of 120° axially to the nozzle bore to the right or to the left with respect to the virtual connection line of the smallest spacing c or with respect to the virtual connection line which is arranged at half the angular range α of the smallest spacing c or has at least one largest spacing d directed radially to the nozzle bore between the central longitudinal axis extending through the center of the nozzle bore of the nozzle and the radially outer margin of the outer contour AK.

A smallest spacing c of a maximum of 20 mm, preferably a maximum of 15 mm, and particularly preferably of a maximum of 12.5 mm, can be observed.

The outer contour can have a circular, polygonal, curved, semi-circular, oval or elliptical shape or a combination thereof. Corners of polygonal outer contours can be rounded.

At least one smallest spacing c of an outer contour in the direction of at least one further plasma torch operated next to the plasma torch should be observed at a plasma torch.

With a plurality of plasma cutting torches operated next to one another and simultaneously, a maximum spacing z1, z2 of 42 mm, advantageously of 32 mm, and particularly advantageously of 27 mm should be observed between virtually extended longitudinal axes of the respective nozzle bores of the nozzles of plasma cutting torches arranged next to one another. A plasma cutting torch can also be arranged having its longitudinal axis during plasma cutting inclined with respect to a perpendicular to a component surface by an angle in the range between 45° and 135°.

A plurality of plasma cutting torches can therefore be operated simultaneously and very closely next to one another using an arrangement in accordance with the invention and there is nevertheless sufficient construction space available for the accommodation of the components required for operation.

In the invention, the ratio of the largest spacing b between two points of the outer margin of the outer contour AK to the smallest spacing b between two points of the outer margin of the outer contour AK, whose respective virtual connection line extends through the central longitudinal axis (M1, M2, M3) extending through the center of the nozzle bore (4.1) of the nozzle (4), should not be larger than 4.

Workpieces having a larger thickness can in particular also be cut using the plasma cutting torch arrangement in accordance with the invention. In this respect, the electrical currents required for this purpose of at least 200 A and also nozzle openings having diameters of at least 2 mm can be used without problems. Oxygen or gas mixtures containing oxygen can be used as the plasma gas. The electrode comprises an emission insert of high-melting metal, e.g. hafnium, tungsten or an alloy thereof, and the electrode holder comprises a material with good heat conductivity, e.g. copper, silver or an alloy thereof.

The wear parts of the plasma torch such as the electrode, the nozzle, the nozzle cap and/or the nozzle protective cap are liquid-cooled.

A plurality of plasma cutting torches of an arrangement in accordance with the invention can be moved by a guide system or by at least one industrial robot for the formation of kerfs.

The invention will be explained in more detail in the following with reference to examples. The features associated with the individual examples are not to be restricted to the respective example. Such features can rather be combined with one another in the most varied form in the invention.

There are shown:

FIG. 1a a plasma cutting torch in accordance with the prior art in a side view;

FIG. 1b a plasma cutting torch in accordance with the prior art with a view of the plasma torch tip;

FIG. 1c a plasma torch cutter in accordance with the prior art with a view of the plasma torch end;

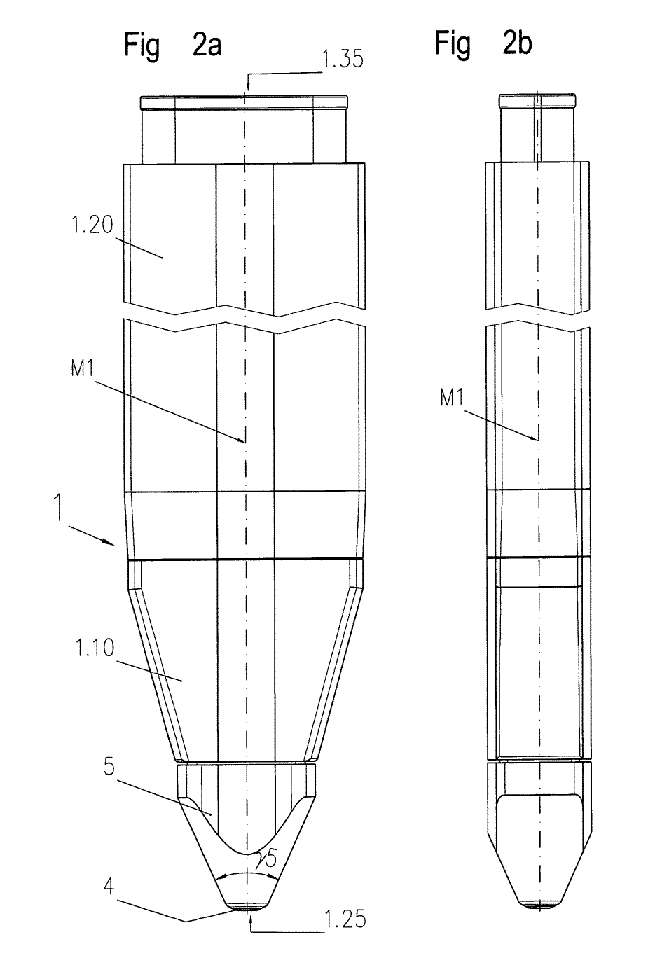

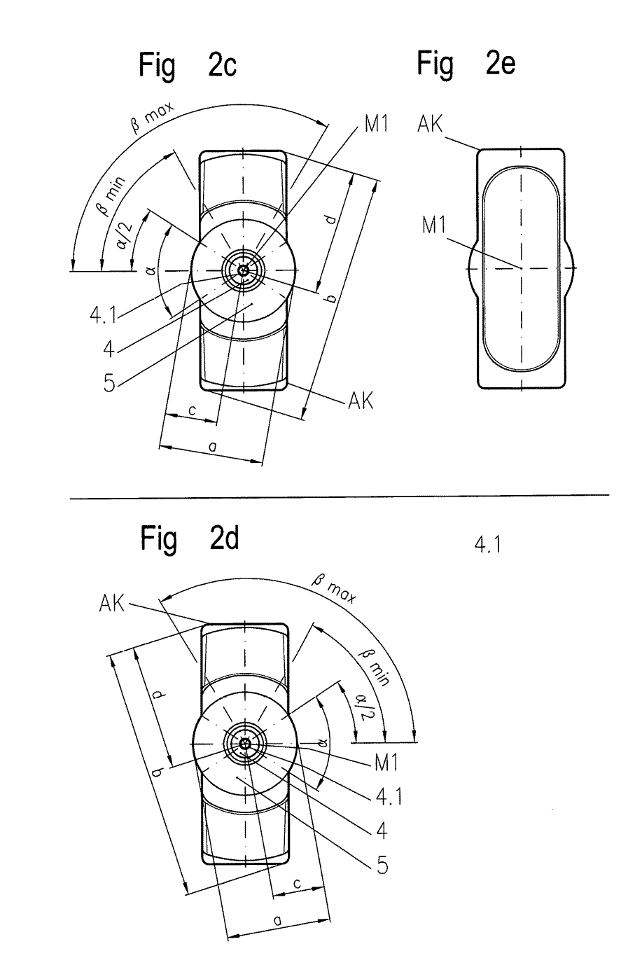

FIG. 2a an example of a plasma cutting torch in accordance with the invention in a side view;

FIG. 2b an example of a plasma cutting torch in accordance with the invention in a side view;

FIG. 2c a plasma cutting torch in accordance with the invention, a view of the plasma torch tip;

FIG. 2d an example of a plasma cutting torch in accordance with the invention with a view of the plasma torch tip;

FIG. 2e an example of a plasma cutting torch in accordance with the invention with a view of the plasma torch end;

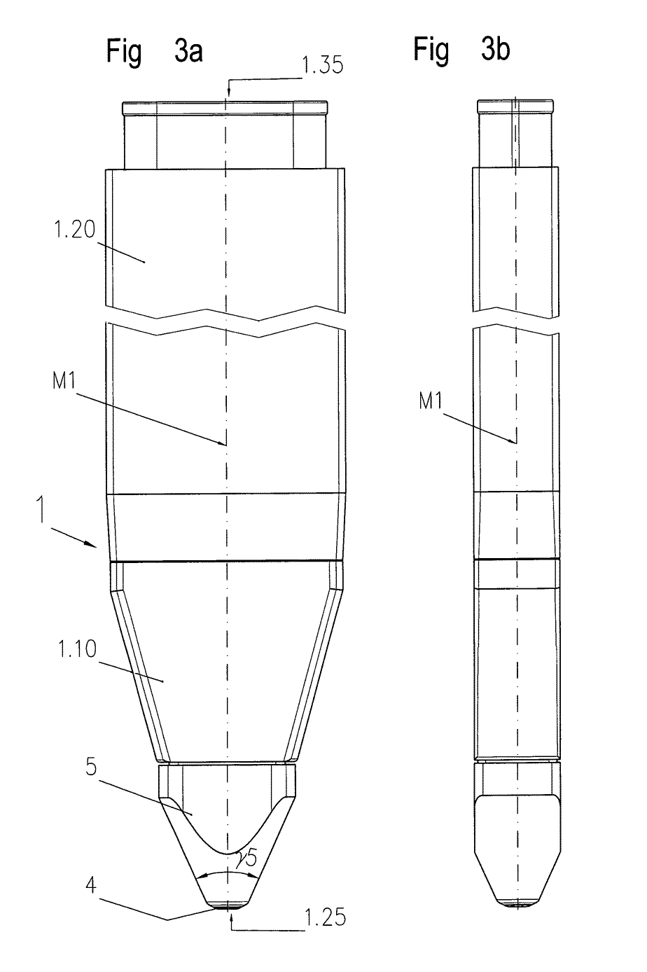

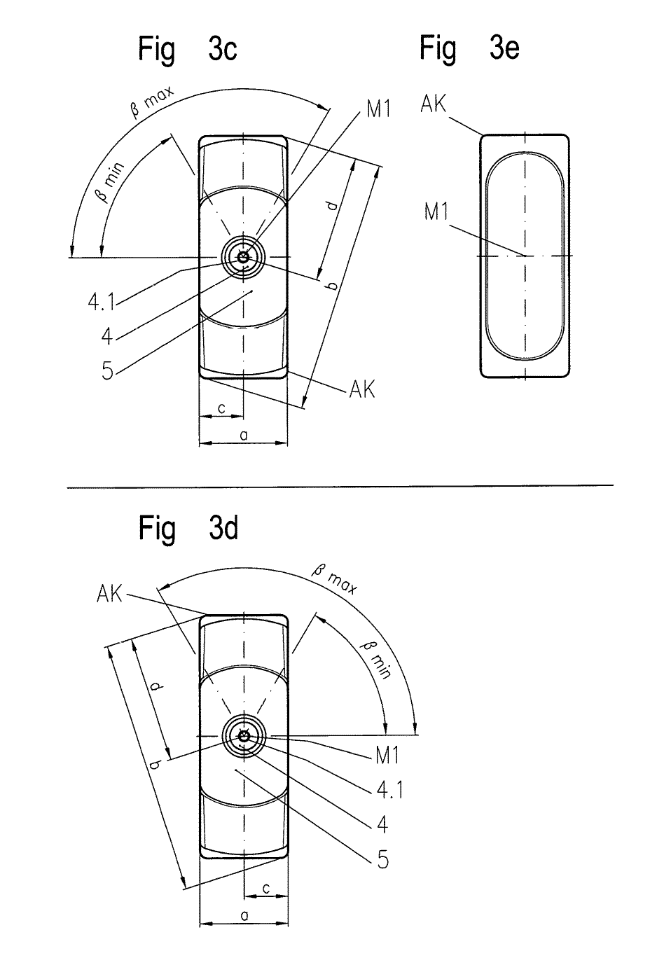

FIG. 3a an example of a plasma cutting torch in accordance with the invention in a side view;

FIG. 3b an example of a plasma cutting torch in accordance with the invention in a side view;

FIG. 3c an example of a plasma cutting torch in accordance with the invention in a view of the plasma torch tip;

FIG. 3d an example of a plasma cutting torch in accordance with the invention in a view of the plasma torch tip;

FIG. 3e an example of a plasma cutting torch in accordance with the invention in a view of the plasma torch end;

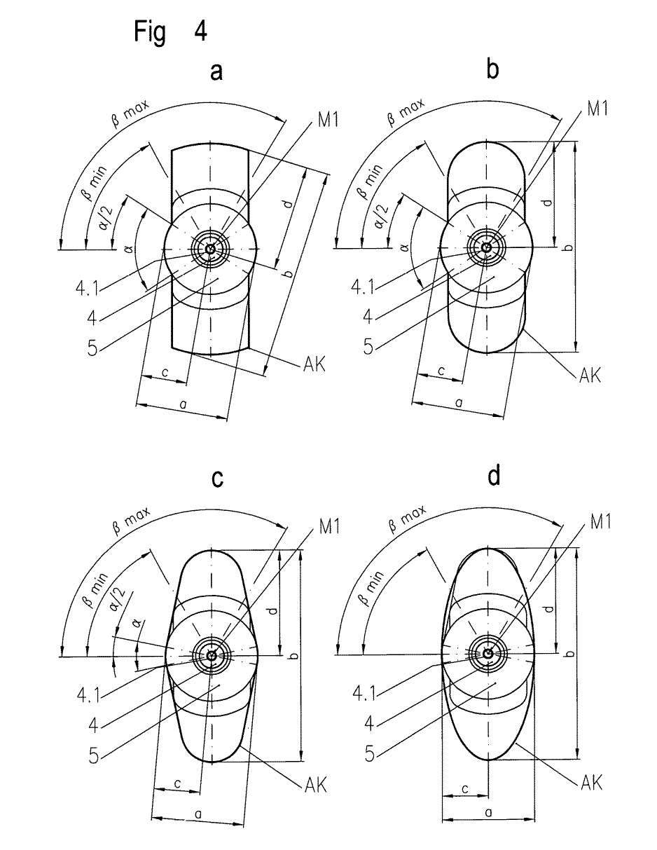

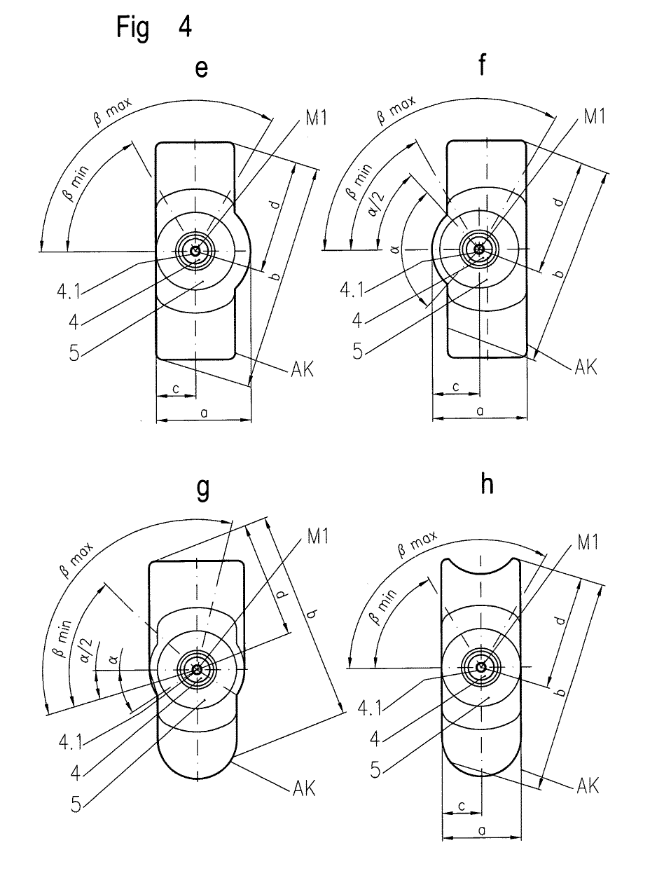

FIGS. 4a-j embodiments for outer contours of a plasma cutting torch viewed from the plasma torch tip;

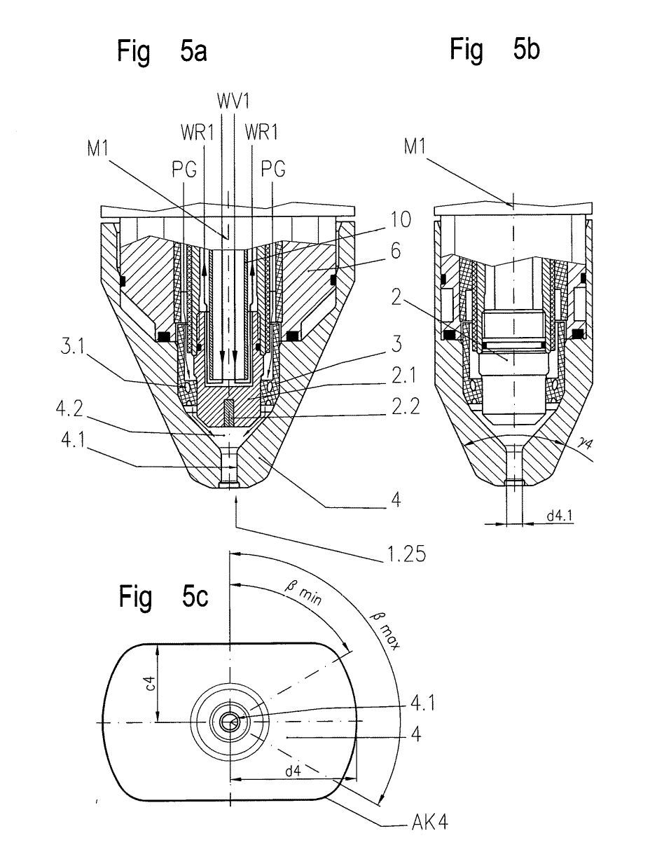

FIG. 5a a sectional image of an arrangement in accordance with the invention in a side view;

FIG. 5b a sectional image of an arrangement in accordance with the invention in a side view;

FIG. 5c a view of a nozzle tip in accordance with FIG. 5a;

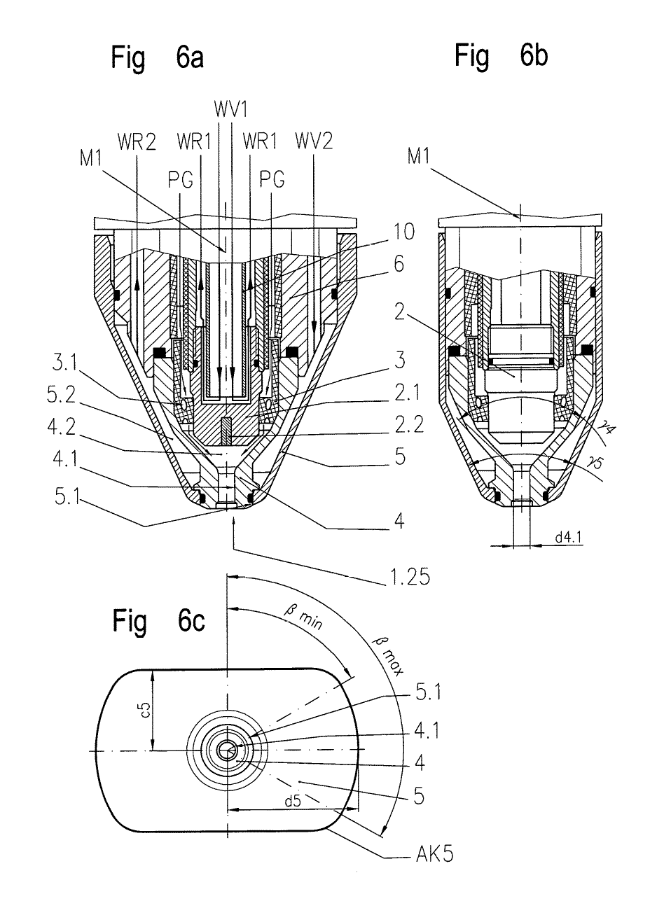

FIG. 6a a sectional image of an arrangement in accordance with the invention in a side view;

FIG. 6b a sectional image of an arrangement in accordance with the invention in a side view;

FIG. 6c a view of a nozzle tip in accordance with FIG. 6a;

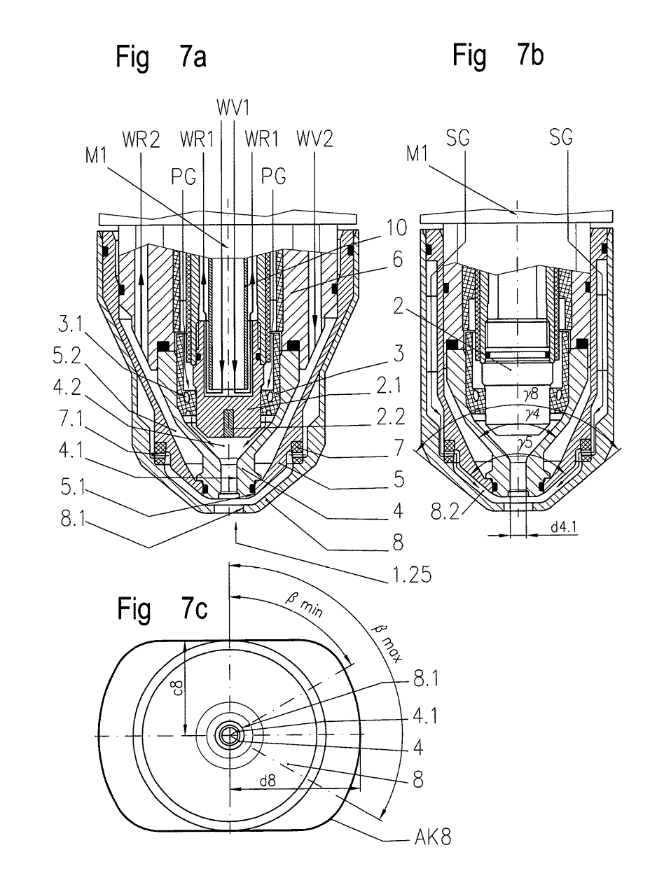

FIG. 7a a sectional image of an arrangement in accordance with the invention in a side view;

FIG. 7b a sectional image of an arrangement in accordance with the invention in a side view;

FIG. 7c a view of a nozzle tip in accordance with FIG. 7a;

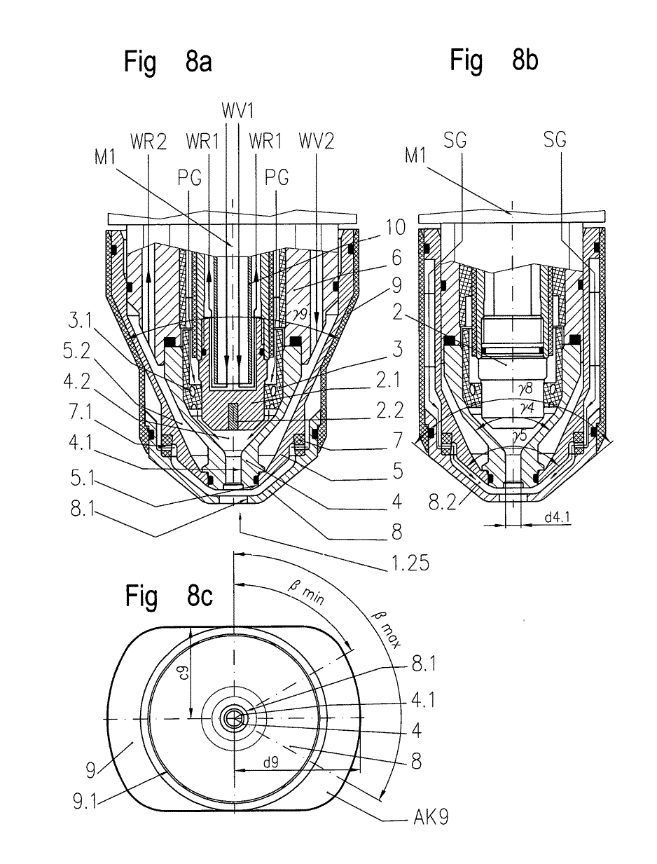

FIG. 8a a sectional image of an arrangement in accordance with the invention in a side view;

FIG. 8b a sectional image of an arrangement in accordance with the invention in a side view;

FIG. 8c a view of a nozzle protective cap tip in accordance with FIG. 8a;

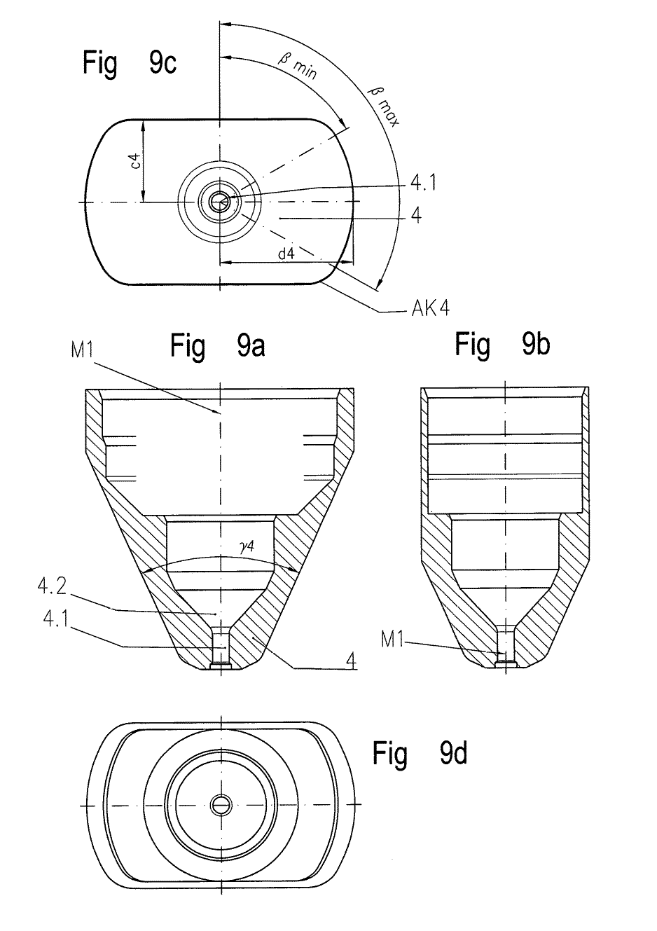

FIG. 9a a sectional image of a nozzle in accordance with the invention in a side view;

FIG. 9b a sectional image of a nozzle in accordance with the invention in a side view,

FIG. 9c a view of a nozzle tip;

FIG. 9d a view of an end opposite to the nozzle tip;

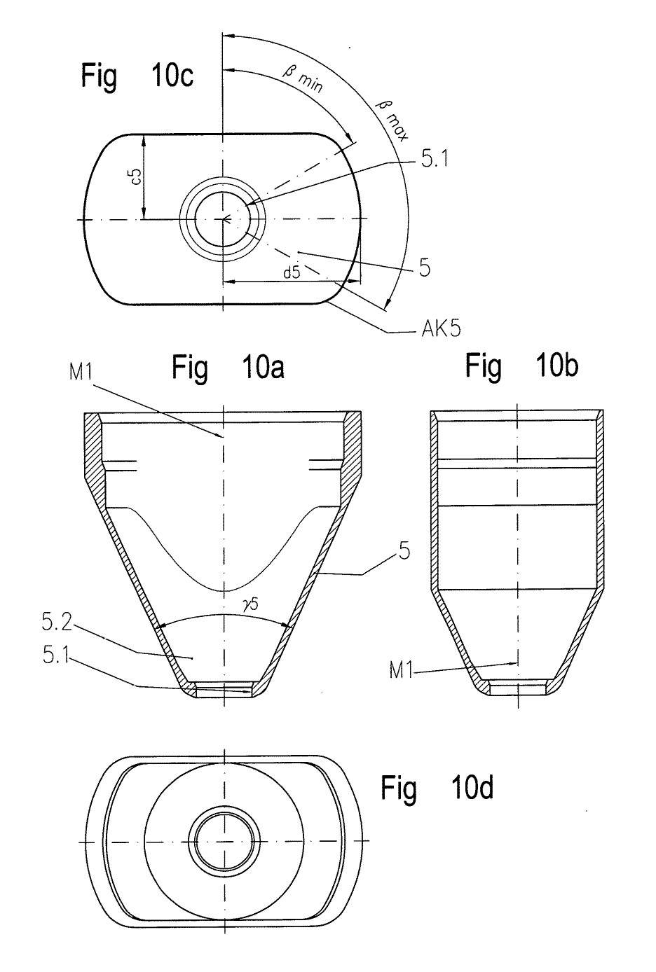

FIG. 10a a sectional image of a nozzle cap in accordance with the invention in a side view;

FIG. 10b a sectional image of a nozzle cap in accordance with the invention in a side view;

FIG. 10c a view of a nozzle cap tip;

FIG. 10d a view of an end opposite to the nozzle cap tip;

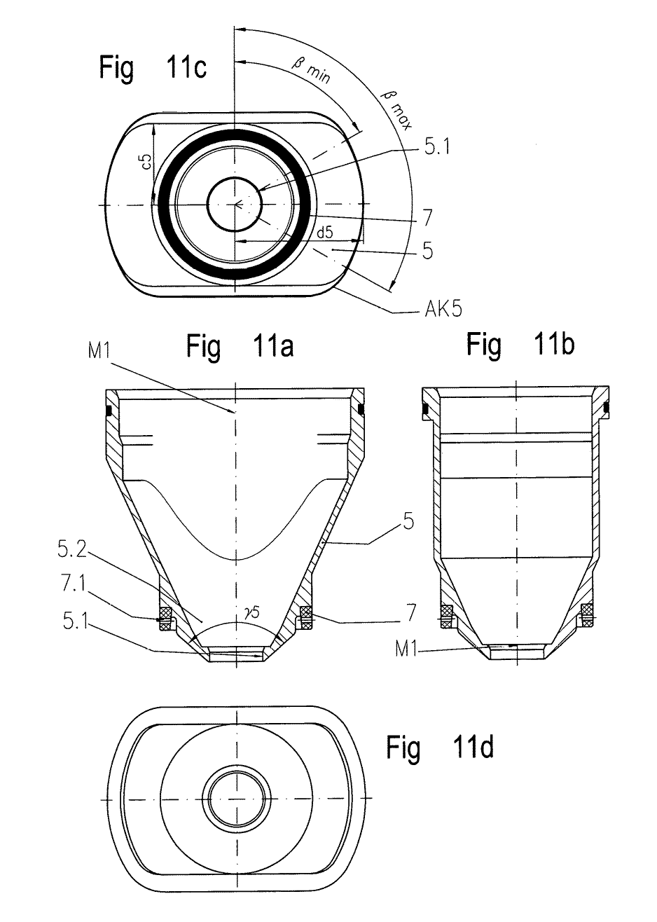

FIG. 11a a sectional image of an arrangement in accordance with the invention of a nozzle cap and a gas passage in a side view;

FIG. 11a a sectional image of an arrangement in accordance with the invention of a nozzle cap and a gas passage in a side view;

FIG. 11c a view of a nozzle cap tip of an arrangement;

FIG. 11d a view of an end of an arrangement opposite to the nozzle cap tip;

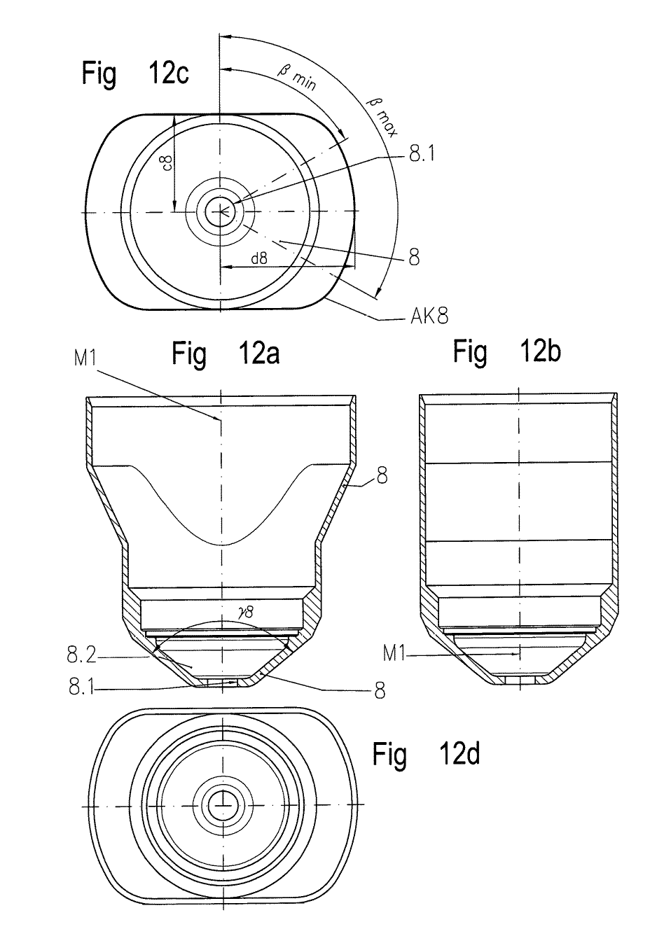

FIG. 12a a sectional image of a nozzle protective cap in accordance with the invention in a side view;

FIG. 12b a sectional image of a nozzle protective cap in accordance with the invention in a side view;

FIG. 12c a view of a nozzle protective cap tip;

FIG. 12d a view of an end opposite to the nozzle protective cap tip;

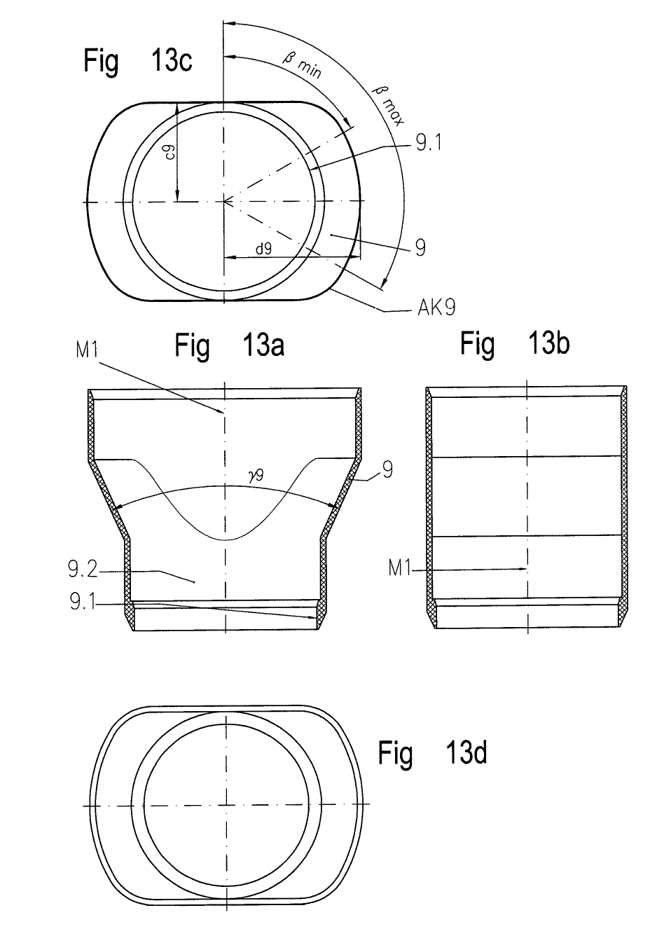

FIG. 13a a sectional image of a nozzle protective cap holder in accordance with the invention in a side view;

FIG. 13b a sectional image of a nozzle protective cap holder in accordance with the invention in a side view;

FIG. 13c a view of a nozzle protective cap holder tip,

FIG. 13d a view of an end opposite to the nozzle protective cap holder tip;

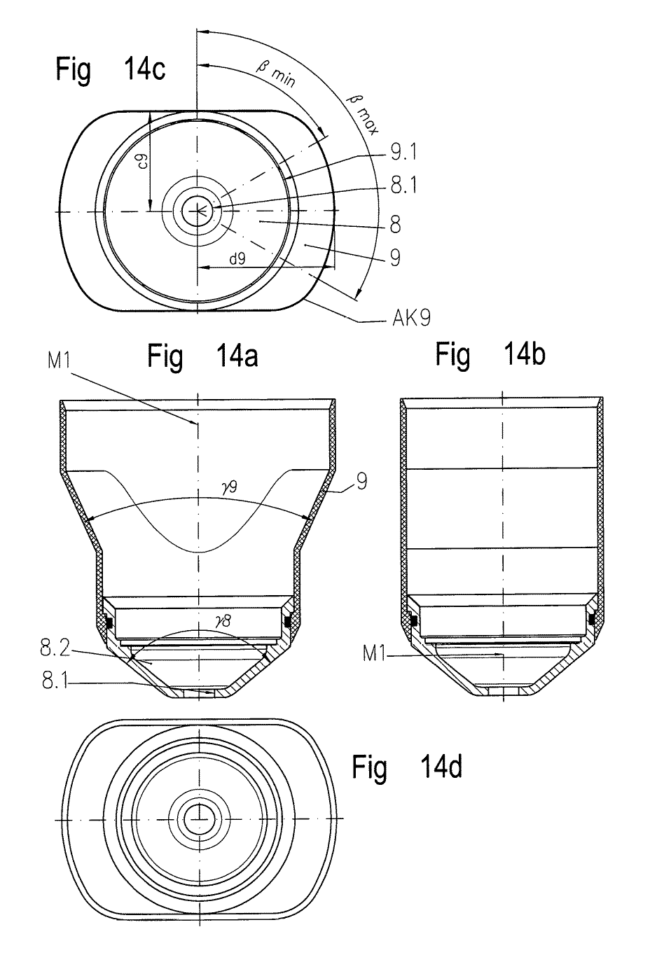

FIG. 14a a sectional image of an arrangement in accordance with the invention and a nozzle protective cap and a nozzle protective cap holder in a side view;

FIG. 14b a sectional image of an arrangement in accordance with the invention and a nozzle protective cap and a nozzle protective cap holder in a side view;

FIG. 14c a view of a nozzle protective cap tip;

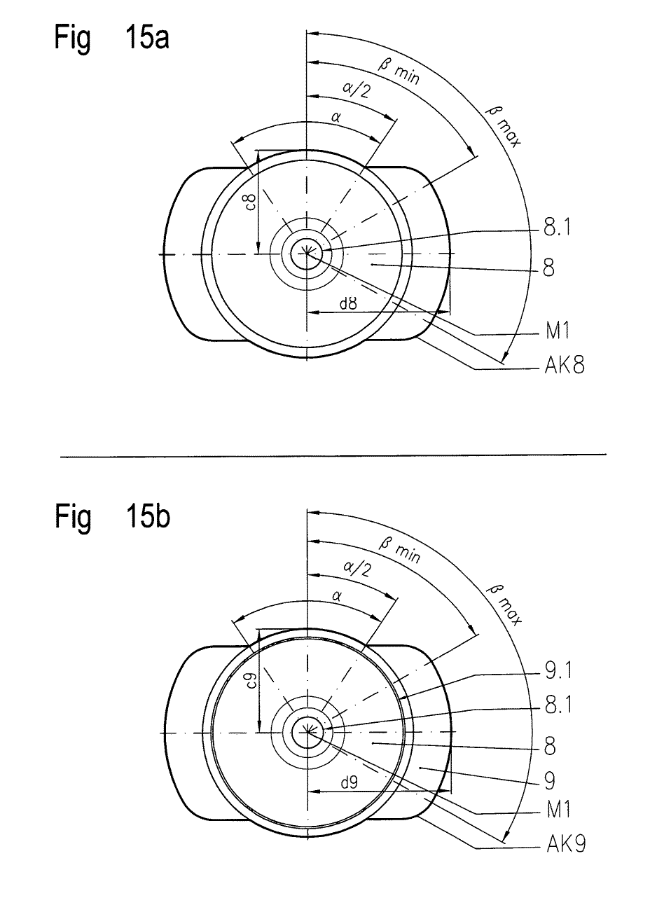

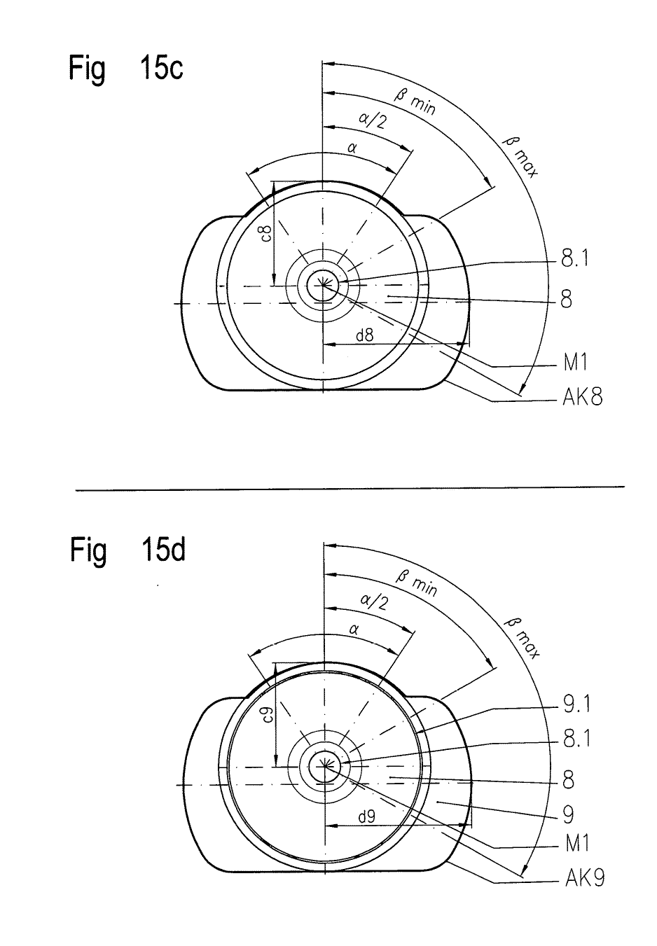

FIG. 14d a view of an end opposite to the nozzle protective cap tip; FIGS. 15a-d embodiments of the outer contour of a nozzle protective cap 8 as well as of an arrangement of a nozzle protective cap 8 and a nozzle protective cap holder 9;

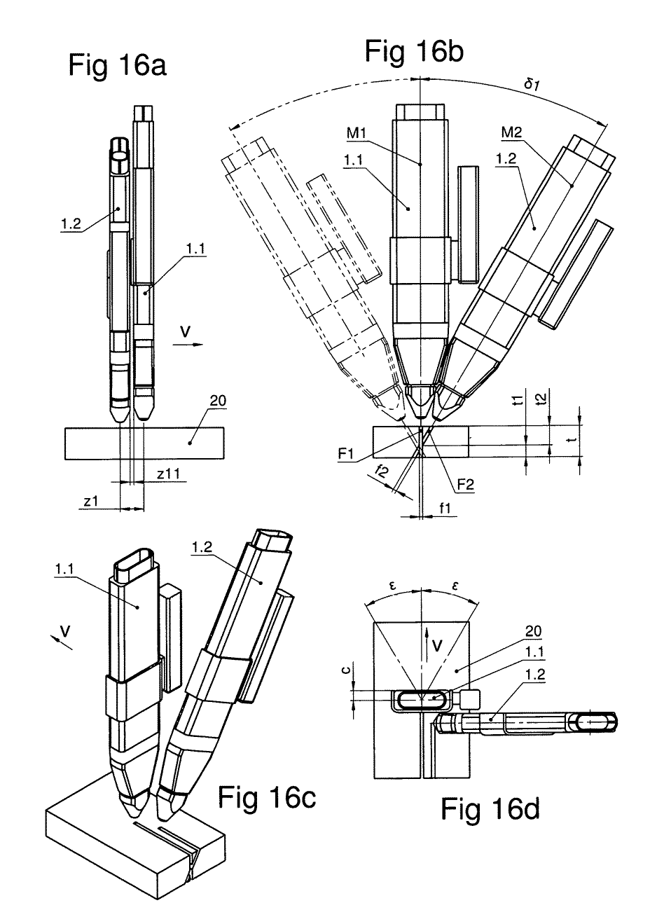

FIGS. 16a-d an arrangement of two plasma cutting torches; and

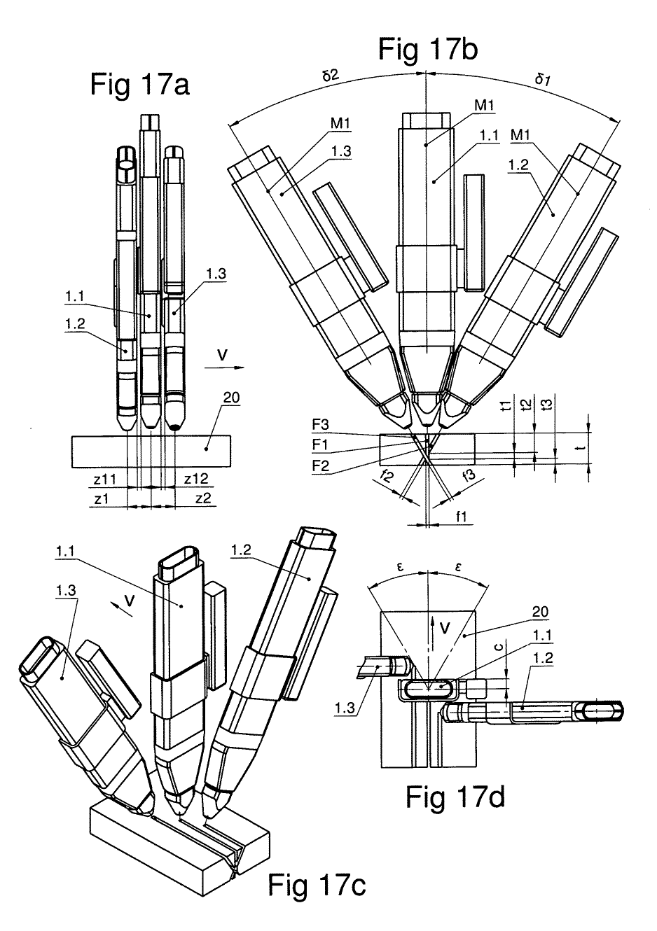

FIGS. 17a-d an arrangement of three plasma cutting torches.

FIGS. 1a to 1c show a plasma cutting torch for machine plasma cutting in accordance with the prior art. The plasma cutting torch 1 substantially comprises a plasma torch head 1.10 and a plasma torch shaft 1.20, wherein the plasma torch head 1.10 and plasma torch shaft 1.20 can also be formed as one component. The wear parts (partially not shown here) such as the electrode, the nozzle, the gas passage are fastened in the plasma torch head 1.10. The nozzle cap 5 and the tip of the nozzle 4 which projects out of the bore of the nozzle cap 5 at the plasma torch tip 1.25 are shown. The connections for electrical lines for current and voltage as well as hoses for gases and cooling media (likewise not shown here) are located in the plasma torch shaft, for example. FIG. 1a shows the side view of such a plasma cutting torch; FIG. 1b shows the view of the plasma torch tip 1.25; and FIG. 1c shows the view of the plasma torch end 1.35. In this respect, the position of the plasma cutting torch 1 at which the plasma jet exits the nozzle bore 4.1 of the nozzle 4 is in this respect called the plasma torch tip 1.25. In FIGS. 1b and 1c, the circular shape of the outer contour AK having the diameter e, here 50 mm by way of example, of the plasma cutting torch 1 is shown which is visible from the front or from the rear. For clarity, the hoses and lines are not shown; they would be led out of the plasma torch shaft 1.20 at the plasma torch end 1.35.

FIGS. 2a to 2e show a variant of a plasma cutting torch in accordance with the invention. The plasma cutting torch 1 substantially comprises a plasma torch head 1.10 and a plasma torch shaft 1.20, wherein the plasma torch head 1.10 and plasma torch shaft 1.20 can also be formed as one component. The wear parts (partially not shown here) such as the electrode, the nozzle, the gas passage are fastened in the plasma torch head. The nozzle cap 5 and the tip of the nozzle 4 which projects out of the bore of the nozzle cap 5 at the plasma torch tip 1.25 are shown. The nozzle cap 5 has a section tapering toward the plasma torch tip at the angle γ5. The connections for electrical lines for current and voltage as well as hoses for gases and cooling media (likewise not shown here) are located in the plasma torch shaft, for example. FIGS. 2a and 2b show side views of the plasma cutting torch 1 which are rotated with respect to one another by 90° about the longitudinal axis M1 extending through the nozzle bore 4.1. FIGS. 2c and 2d show the view of the plasma torch tip 1.25 and FIG. 2e shows the view of the plasma torch end 1.35. In this respect, the position of the plasma torch 1 at which the plasma jet exits the nozzle bore 4.1 of the nozzle 4 is in this respect called the plasma torch tip 1.25. For clarity, the hoses and lines are not shown; they would be led out of the plasma torch shaft 1.20 at the plasma torch end 1.35. The outer contour seen for the plasma torch tip 1.25 and/or the plasma torch end 1.35 is marked by AK. The outer contour AK is not circular and the cross-section is not rotationally symmetrical about the longitudinal axis M1.

In FIGS. 2c and 2d, the nozzle cap 5 and the tip of the nozzle 4 with the nozzle bore 4.1 can be recognized. The longitudinal axis M1 is the virtual center line which is guided perpendicular through the nozzle bore 4.1.

In FIG. 2c, a smallest spacing c, here dimensioned with 14 mm by way of example at the left, is shown between the outer contour AK and the longitudinal axis M1 extending through the center of the nozzle bore 4.1 of the nozzle 4. This smallest spacing c extends over an angular range α, here 67° by way of example. In a region between the minimum angle βₘᵢₙ of 60° and the maximum angle βₘₐₓ of 120° rotated offset axially to the nozzle bore 4.1 to the right to the virtual connection line which lies at half (α/2) of the angular range α of the smallest spacing c, a largest spacing d directed radially to the nozzle bore 4.1, here dimensioned with 35 mm at the right by way of example, is shown between the outer contour AK and the longitudinal axis M1 extending through the center of the nozzle bore 4.1 of the nozzle 4.

A smallest space a (here 2*c by way of example), here 28 mm by way of example, directed radially to the nozzle bore 4.1 between two points of the outer contour AK is equally shown whose virtual straight connection line runs virtually through the center of the nozzle bore 4.1 of the nozzle 4 and intersects the longitudinal axis M1. This smallest spacing a extends over an angular range α, here 67° by way of example. In a region between the minimum angle βₘᵢₙ of 60° and the maximum angle βₘₐₓ of 120° rotated offset axially to the nozzle bore 4.1 to the right to the virtual connection line which lies at half (α/2) of the angular range of the smallest spacing a, a largest spacing b directed radially to the nozzle bore 4.1, here dimensioned with 70 mm by way of example, is observed between two points of the outer contour AK whose virtual straight connection line intersects the longitudinal axis M1 extending through the center of the nozzle bore 4.1 of the nozzle 4.

The region designated by a is shown at the left in FIG. 2; it is equally also present, as shown in FIG. 2d, at the oppositely disposed right side of the plasma cutting torch and is dimensioned in this manner. The angular region between the minimum angle βₘᵢₙ of 60° and the maximum angle βₘₐₓ of 120° can equally be offset to the left or right, also as shown in FIG. 2d.

In contrast to the plasma cutting torch in accordance with the prior art (FIGS. 1a to 1c), a machining with comparable cutting currents of more than 200 A is possible due to this construction shape and a plurality of plasma cutting torches can be arranged next to one another with a spacing between the nozzle bores which is as small as possible.

FIGS. 3a to 3d show a further construction shape of a plasma cutting torch 1 in accordance with the invention which above all differs from that shown in FIGS. 2a to 2d in that there is no angular region a in which the smallest spacing c and the smallest spacing a exist. A respective exactly one spacing c and a respective exactly one spacing a are present here at the left side of the plasma cutting torch 1, as shown in FIG. 3c, and at the right side, as shown in FIG. 3d.

FIGS. 3a and 3b show side views of the plasma cutting torch which are rotated with respect to one another by 90° about the longitudinal axis M1 extending through the nozzle bore 4.1. FIGS. 3c and 3d show the view of the plasma torch tip 1.25 and FIG. 2e shows the view of the plasma torch end 1.35 arranged opposite thereto. In this respect, the position of the plasma cutting torch 1 at which the plasma jet exits the nozzle bore 4.1 of the nozzle 4 is called the plasma torch tip 1.25. For clarity, the hoses and lines are not shown; they would be led out of the plasma torch shaft 1.20 at the plasma torch end 1.35. The outer contour seen for the plasma torch tip 1.25 and/or the plasma torch end 1.35 is marked by AK. The outer contour AK is not circular/rotationally symmetrical about the longitudinal axis M1.

In FIGS. 3c and 3d, the nozzle cap 5 and the tip of the nozzle 4 with the nozzle bore 4.1 can be recognized. The longitudinal axis M1 is the virtual center line which extends perpendicular through the nozzle bore 4.1.

In FIG. 3c, a smallest spacing c, here dimensioned with 12 mm by way of example, is shown at the left side between the outer contour AK and the longitudinal axis M1 extending through the center of the nozzle bore 4.1 of the nozzle 4. In a region between the minimum angle βₘᵢₙ of 60° and the maximum angle βₘₐₓ of 120° rotated offset axially to the nozzle bore 4.1 to the right to the virtual connection line, a largest spacing d directed radially to the nozzle bore 4.1, here at the right and dimensioned with 35 mm by way of example, is shown which extends between the outer contour AK and the longitudinal axis M1 extending through the center of the nozzle bore 4.1 of the nozzle 4.

A smallest spacing a, here 28 mm by way of example, directed radially to the nozzle bore 4.1 between two points of the outer contour AK is equally shown whose virtual straight connection line intersects the virtual longitudinal axis M1 extending through the center of the nozzle bore 4.1 of the nozzle 4. In a region between the minimum angle βₘᵢₙ of 60° and the maximum angle βₘₐₓ of 120° rotated offset axially to the nozzle bore 4.1 to the right to the virtual connection line, a largest spacing b directed radially to the nozzle bore 4.1, here at the right and dimensioned with 70 mm by way of example, is shown between two points of the outer contour AK whose virtual straight connection line intersects the longitudinal axis M1 extending through the center of the nozzle bore 4.1 of the nozzle 4.

In FIG. 3d, a smallest spacing c, here dimensioned with 12 mm by way of example, is shown at the right side between the outer contour AK and the longitudinal axis M1 extending through the center of the nozzle bore 4.1 of the nozzle 4. In a region between the minimum angle βₘᵢₙ of 60° and the maximum angle βₘₐₓ of 120° rotated offset axially to the nozzle bore 4.1 to the left to the virtual connection line of the smallest spacing c, a largest spacing d directed radially to the nozzle bore 4.1, here at the left and 35 mm by way of example, is shown which extends between the outer contour AK and the longitudinal axis M1 extending through the center of the nozzle bore 4.1 of the nozzle 4.

A smallest spacing a, here 28 mm by way of example, directed radially to the nozzle bore 4.1 between two points of the outer contour AK is equally shown whose virtual straight connection line intersects the longitudinal axis M1 virtually extending through the center of the nozzle bore 4.1 of the nozzle 4. In a region between the minimum angle βₘᵢₙ of 60° and the maximum angle βₘₐₓ of 120° rotated offset axially to the nozzle bore 4.1 to the left to the virtual connection line of the smallest spacing a, a largest spacing b directed radially to the nozzle bore 4.1, here at the left and dimensioned with 70 mm by way of example, is shown between two points of the outer contour AK whose virtual straight connection line intersects the longitudinal axis M1 extending through the center of the nozzle bore 4.1 of the nozzle 4.

FIGS. 4a to 4h show different embodiments of plasma cutting torches in accordance with the invention with a view of the plasma torch tip 1.25. In this respect, the smallest spacings c and a as well as the largest spacings d and b are indicated by way of example. Examples are shown in FIGS. 4a, 4b, 4c, 4f, and 4g in which there are one or more angular regions a in which the smallest spacings c and a are observed. In FIGS. 4a and 4b α=67°; in FIG. 4c α=23°; in FIG. 4f α is 96°; and in FIG. 4g α=33°.

In FIGS. 4a, 4b, 4c and 4g, there is a second equally large angular range α to the right of the nozzle bore 4.1 beside the angular range α shown to the left of the nozzle bore 4.1. This is not shown for better clarity, but can be deduced from the observation of FIGS. 2c and 2d.

The angular range α is only to the left of the nozzle bore 4.1 in FIG. 4f, while exactly one smallest spacing c, but no angular range α is observed to the right of the nozzle bore.

Exactly one respective smallest spacing c is observed to the left and to the right of the nozzle bore 4.1 in FIGS. 4d and 4j. The angular range α does not exist or amounts to 0°.

Only a smallest spacing c to the left of the nozzle bore 4.1 is observed in FIG. 4e.

Equally embodiments are shown in FIGS. 4e, 4f, 4g and 4h which are asymmetrical by way of example.

FIGS. 5a to 5c show an arrangement by way of example comprising an electrode 2, a nozzle 4 and a gas passage 3 which is arranged between the electrode 2 and the nozzle 4. FIGS. 5a and 5b show sectional representations of the side views of the plasma cutting torch 1 which are rotated with respect to one another by 90° about the longitudinal axis M1 extending through the nozzle bore 4.1.

The plasma gas PG flows through the bores 3.1 of the gas passage 3 into the inner space 4.2 between the electrode 2 and the nozzle 4 and exits the nozzle bore 4.1.

The nozzle 4 is fastened to the nozzle holder 6. The nozzle 4 has a section tapering conically at the angle γ4, here 48° by way of example, toward the nozzle tip in the direction toward the nozzle bore 4.1.

The electrode 2 is directly liquid-cooled; this means it is in direct contact by touching with a cooling liquid, in the simplest case water. The cooling liquid flows through the cooling pipe 10 into the inner space of the electrode 2 (coolant feed WV1) and back again through the intermediate space between the cooling pipe 10 and the electrode 2 (coolant return WR1). The electrode 2 here consists of an emission insert 2.2 and an electrode holder 2.1. The emission insert 2.2 comprises a high-melting material, e.g. hafnium, tungsten or an alloy thereof; and the electrode holder 2.1 is formed from a material with good heat conductivity, e.g. copper, silver or alloys thereof. This ensures an effective cooling of the electrode 2.

FIG. 5c shows the view of the nozzle tip with the nozzle bore 4.1. If the arrangement is installed in the plasma cutting torch 1, it would correspond to the plasma torch tip 1.25. An outer contour AK4 of the arrangement is shown here from the direction of the nozzle bore 4.1 which is identical to the outer contour AK4 of the nozzle 4 in accordance with FIG. 9c.

A respective exactly one smallest spacing c4 directed radially to the nozzle bore 4.1 is observed above and below the nozzle bore 4.1. This means that in this example of an arrangement exactly two smallest spacings c4 directed radially to the nozzle bore 4.1 are observed between the longitudinal axis M1 extending through the center of the nozzle bore 4.1 of the nozzle 4 and the outer contour AK4.

An angular range α does not exist in this embodiment or it amounts to 0°. It is, however, also possible that the outer contour AK of the arrangement is configured such that the smallest spacing c4 extends in an angular range α of a maximum of 120° or, better, of a maximum of 70°. It is equally possible that the arrangement only has one smallest spacing c4 directed radially to the nozzle bore 4.1 in one direction. A pictorial illustration was dispensed with here; however, it can be deduced from the examples of FIGS. 4a to 4j and 15a to 15d.

The outer contour AK4 has at least one largest spacing d4 between the longitudinal axis M1 extending through the center of the nozzle bore 4.1 of the nozzle 4 and the outer contour AK4 which is directed radially to the nozzle bore 4.1 in the angular range which is rotated axially to the nozzle bore 4.1 to the right or to the left to the virtual connection line of the smallest spacing c4 between the minimum angle βₘᵢₙ of 60° and the maximum angle βₘₐₓ of 120°. The angular range rotated to the right by βₘᵢₙ to βₘₐₓ is shown.

The smallest spacing c4 here amounts by way of example to 12 mm and the largest spacing d4 by way of example to 19 mm. The smallest spacing c4 thus amounts to less than ⅔ of the largest spacing d4.

The nozzle bore here has a minimum diameter d4.1 of 2.4 mm and is suitable for the cutting with currents of at least 200 A or even more than 250 A.

FIGS. 6a to 6c show an arrangement by way of example comprising an electrode 2, a nozzle 4, a gas passage 3 which is arranged between the electrode 2 and the nozzle 4 as well as a nozzle cap 5. FIGS. 6a and 6b show sectional representations of the side views of the plasma cutting torch 1 which are rotated with respect to one another by 90° about the longitudinal axis M1 extending through the nozzle bore 4.1. The design and the function correspond to that of the example described in FIGS. 5a-c so that a detailed description can be dispensed with. The same elements are marked by the same reference numerals.

The outer surface of the nozzle 4 has a section tapering conically at the angle γ4, here 80° by way of example, toward the nozzle tip in the direction toward the nozzle bore 4.1.

The outer surface of the nozzle cap 5 has a section tapering conically at the angle γ5, here 48° by way of example, toward the nozzle cap tip in the direction of the nozzle cap bore 5.1.

FIG. 6c shows the view of the nozzle tip with the nozzle bore 4.1 and the nozzle cap tip with the nozzle cap bore 5.1. If the arrangement is installed in the plasma cutting torch 1, it would correspond to the plasma torch tip 1.25. An outer contour AK5 of the arrangement is shown here from the direction of the nozzle cap bore 5.1 which is identical to the outer contour of the nozzle cap 5 in accordance with FIG. 10c.

Since the centers of the nozzle bore 4.1 and of the nozzle cap bore 5.1 coincide in this exemplary arrangement, reference is only made to the center of the nozzle bore 4.1 and the to the longitudinal axis M1.

A respective exactly one smallest spacing c5 directed radially to the nozzle bore 4.1 is observed above and below the nozzle bore 4.1. This means that in this example in the arrangement exactly two smallest spacings c5 directed radially to the nozzle bore 4.1 are observed between the longitudinal axis M1 extending through the center of the nozzle bore 4.1 of the nozzle 4 and the outer contour AK5.

An angular range α does not exist in this embodiment or it amounts to 0°. It is, however, also possible that the outer contour AK of the arrangement is configured such that the smallest spacing c5 extends in an angular range α of a maximum of 120° or, better, of a maximum of 70°. It is equally possible that exactly one smallest spacing c5 directed radially to the nozzle bore 4.1 is observed between the longitudinal axis M1 extending through the center of the nozzle bore 4.1 of the nozzle 4 in the arrangement. A pictorial illustration was dispensed with here; however, it can be deduced from the examples of FIGS. 4a to 4j and 15a to 15d.

The outer contour AK5 has at least one largest spacing d5 between the longitudinal axis M1 extending through the center of the nozzle bore 4.1 of the nozzle 4 and the outer contour AK4 which is directed radially to the nozzle bore 4.1 in the angular range which is rotated axially in the nozzle bore 4.1 to the right or to the left to the virtual connection line of the smallest spacing c5 between the minimum angle βₘᵢₙ of 60° and the maximum angle βₘₐₓ of 120°. The angular range rotated to the right by βₘᵢₙ to βₘₐₓ is shown.

The smallest spacing c5 here amounts by way of example to 12 mm and the largest spacing d5 by way of example to 19 mm. The smallest spacing c5 thus amounts to less than ⅔ of the largest spacing d5.

The nozzle bore here has a minimum diameter d4.1 of 2.4 mm and is suitable for the cutting with currents of at least 200 A or even more than 250 A.

FIGS. 7a to 7c show by way of example an arrangement comprising an electrode 2, a nozzle 4, a gas passage 3 which is arranged between the electrode 2 and the nozzle 4, a nozzle cap 5, a nozzle protective cap 8 and a gas passage 7 which is arranged between the nozzle cap 5 and the nozzle protective cap 8. FIGS. 7a and 7b show sectional representations of the side views of the plasma cutting torch 1 which are rotated with respect to one another by 90° about the longitudinal axis M1 extending through the nozzle bore 4.1.

The plasma gas PG flows through the bores 3.1 of the gas passage 3 into the space 4.2 between the electrode 2 and the nozzle 4 and exits the nozzle bore 4.1 and then the nozzle protective cap bore 8.1.

The secondary gas SG flow through the bores 7.1 of the gas passage 7 into the space 8.2 between the nozzle cap 5 and the nozzle protective cap 8 and exits the nozzle protective cap bore 8.1.

The nozzle 4 is fastened to the nozzle holder 6 with the aid of the nozzle cap 5.

The nozzle protective cap 8 is fastened to the nozzle cap 5 by way of example here. It is also possible that the nozzle protective gap 8 is fastened to the torch body 10.1, to the nozzle holder 6 or to another part of the plasma cutting torch 1. As a rule, a fastening takes place which allows an electrical insulation of the nozzle protective cap 8 with respect to the nozzle 4.

The outer surface of the nozzle 4 has a section tapering conically at the angle γ4, here 80° by way of example, toward the nozzle tip in the direction toward the nozzle bore 4.1.

The outer surface of the nozzle cap 5 has a section tapering conically at the angle γ5, here 100° by way of example, toward the nozzle cap tip in the direction of the nozzle cap bore 5.1.

The outer surface of the nozzle protective cap 8 has a section tapering conically at the angle γ8, here 100° by way of example, toward the nozzle protective cap tip in the direction of the nozzle protective cap bore 8.1.

Otherwise the embodiment in this example corresponds to the examples shown in FIGS. 5a-c and 6a-c.

FIG. 7c shows the view of the nozzle protective cap tip with the nozzle protective cap bore 8.1 and, visible therein, the nozzle tip with the nozzle bore 4.1. If the arrangement is installed in the plasma cutting torch 1, it would correspond to the plasma torch tip 1.25. An outer contour AK8 of the arrangement is shown here from the direction of the nozzle protective cap bore 8.1 which is identical to the outer contour AK8 of the nozzle protective cap 8 of FIG. 12c.

Since the centers of the nozzle bore 4.1 and of the nozzle cap bore 5.1 and of the nozzle protective cap bore 8.1 coincide in this exemplary arrangement, reference is only made to the center of the nozzle bore 4.1 and to the longitudinal axis M1.

A respective exactly one smallest spacing c8 directed radially to the nozzle bore 4.1 is observed above and below the nozzle bore 4.1. This means that in this example in the arrangement exactly two smallest spacings c8 directed radially to the nozzle bore 4.1 are observed between the longitudinal axis M1 extending through the center of the nozzle bore 4.1 of the nozzle 4 and the outer contour AK8.

An angular range α does not exist in this embodiment or it amounts to 0°. It is, however, also possible that the outer contour of the arrangement is configured such that the smallest spacing c8 extends in an angular range α of a maximum of 120° or, better, of a maximum of 70°. It is equally possible that only a smallest direction c8 directed radially to the nozzle bore 4.1 is observed in one direction. A pictorial illustration was dispensed with here; however, it can be deduced from the examples of FIGS. 4a to 4j and 15a to 15d.

The outer contour AK8 has at least one largest spacing d8 between the longitudinal axis M1 extending through the center of the nozzle bore 4.1 of the nozzle 4 and the outer contour AK8 which is directed radially to the nozzle bore 4.1 in the angular range which is rotated axially to the nozzle bore 4.1 to the right or to the left to the virtual connection line of the smallest spacing c8 between the minimum angle βₘᵢₙ of 60° and the maximum angle βₘₐₓ of 120°. The angular range rotated to the right by βₘᵢₙ to βₘₐₓ is shown.

The smallest spacing c8 here amounts by way of example to 14 mm and the largest spacing d8 by way of example to 19 mm. The smallest spacing c8 thus amounts to less than ¾ of the largest spacing d8.

The nozzle bore 4.1 here has a minimum diameter d4.1 of 2.4 mm and is suitable for the cutting with currents of at least 200 A or even more than 250 A.

FIGS. 8a to 8c show by way of example an arrangement comprising an electrode 2, a nozzle 4, a gas passage which is arranged between the electrode 2 and the nozzle 4, a nozzle cap 5, a nozzle protective cap 8 and a gas passage 7 which is arranged between the nozzle cap 5 and the nozzle protective cap 8 as well as a nozzle protective cap holder 9.

The difference from FIGS. 7a to 7c is that the nozzle protective cap 8 is held by a nozzle protective cap holder 9. The nozzle protective cap holder 9 is, like the nozzle protective cap 8 of FIGS. 7a to c, fastened to the nozzle cap 5 or to the torch body 1.10, to the nozzle holder 6 or to another part of the plasma cutting torch 1.

FIGS. 8a and 8b show sectional representations of the side views of the plasma cutting torch 1 which are rotated with respect to one another by 90° about the longitudinal axis M1 extending through the nozzle bore 4.1.

FIG. 8c shows the view of the nozzle protective cap tip with the nozzle protective cap bore 8.1 and, visible therein, the nozzle tip with the nozzle bore 4.1. If the arrangement is installed in the plasma cutting torch 1, it would correspond to the plasma torch tip 1.25. Here, an outer contour AK9 of the arrangement is shown from the direction of the nozzle protective cap bore 8.1 which is identical to the outer contour of the nozzle protective cap holder 9 of FIG. 13c and the arrangement of FIG. 14c.

The statements made under FIGS. 7a to 7c otherwise apply, but with the difference that the outer contour AK9 of the nozzle protective cap holder 9 takes the place of the outer contour AK8 of the nozzle protective cap 8. This is also associated with the fact that the smallest spacing c9 takes the place of the smallest spacing c8 and the largest spacing d9 takes the place of the largest spacing d8.

FIGS. 9a to 9d show a nozzle 4 in accordance with the invention which is installed in an arrangement in accordance with FIGS. 5a to 5c. FIGS. 9a and 9b show sectional representations of the side views of the nozzle 4 which are rotated with respect to one another by 90° about the longitudinal axis M1 extending through the nozzle bore 4.1. The nozzle 4 has a section tapering conically at the angle γ4, here 48° by way of example, toward the nozzle tip in the direction of the nozzle bore 4.1.

FIG. 9c shows the view of the nozzle tip with the nozzle bore 4.1 and the outer contour AK4 of the nozzle 4 can be recognized. If the nozzle 4 is installed in the plasma cutting torch 1, it would correspond to the plasma torch tip 1.25.

A respective exactly one smallest spacing c4 directed radially to the nozzle bore 4.1 is observed above and below the nozzle bore 4.1. This means that in this example the arrangement has exactly two smallest spacings c4 directed radially to the nozzle bore 4.1 between the longitudinal axis M1 extending through the center of the nozzle bore 4.1 of the nozzle 4 and the outer contour AK4.

An angular range α does not exist in this embodiment or it amounts to 0°. It is, however, also possible that the outer contour AK4 is configured such that the smallest spacing c4 extends in an angular range α of a maximum of 120° or, preferably of a maximum of 70°. It is equally possible that the nozzle 4 observes exactly one smallest spacing c4 directed radially to the nozzle bore 4.1. A pictorial illustration was dispensed with here; however, it can be deduced from the examples of FIGS. 4a to 4j and 15a to 15d.

The outer contour AK4 has at least one largest spacing d4 between the longitudinal axis M1 extending through the center of the nozzle bore 4.1 of the nozzle 4 and the outer contour AK4 which is directed radially to the nozzle bore 4.1 in the angular range which is rotated axially to the nozzle bore 4.1 to the right or to the left to the virtual connection line of the smallest spacing c4 between the minimum angle βₘᵢₙ of 60° and the maximum angle βₘₐₓ of 120°. The angular range rotated to the right by βₘᵢₙ to βₘₐₓ is shown.

The smallest spacing c4 here amounts by way of example to 12 mm and the largest spacing d4 by way of example to 19 mm. The smallest spacing c4 thus amounts to less than ⅔ of the largest spacing d4.

FIG. 9d shows the view opposite to FIG. 9c of the end of the nozzle 4 opposite the nozzle tip and the nozzle bore 4.1.

The outer contour AK4 of the nozzle 4 is not circular/rotationally symmetrical about the longitudinal axis M1.

The nozzle bore here has a minimum diameter d4.1 of 2.4 mm and is suitable for the cutting with currents of at least 200 A or even more than 250 A.

FIGS. 10a to 10d show a nozzle cap 5 in accordance with the invention which is installed in an arrangement in accordance with FIGS. 6a to 6c. FIGS. 10a and 10b show sectional representations of the side views of the nozzle 5 which are rotated with respect to one another by 90° about the longitudinal axis M1 extending through the nozzle cap bore 5.1. The nozzle cap 5 has a section tapering conically at the angle γ5, here 48° by way of example, toward the nozzle cap tip in the direction of the nozzle cap bore 5.1.

FIG. 10c shows the view of the nozzle cap tip with the nozzle cap bore 5.1 and the outer contour AK5 of the nozzle cap 5 can be seen. If the nozzle cap 5 is installed in the plasma cutting torch 1, it would correspond to the plasma torch tip 1.25.

A respective exactly one smallest spacing c5 directed radially to the nozzle cap bore 5.1 is observed above and below the nozzle cap bore 5.1. This means that in this example exactly two smallest spacings c5 directed radially to the nozzle cap bore 5.1 are observed between the longitudinal axis M1 extending through the center of the nozzle cap bore 5.1 of the nozzle cap 5 and the outer contour AK5.

An angular range α does not exist in this embodiment or it amounts to 0°. It is, however, also possible that the outer contour AK5 is configured such that the smallest spacing c5 is observed in an angular range α of a maximum of 120° or, better, of a maximum of 70°. It is equally possible that the nozzle cap 5 has exactly one smallest spacing c5 directed radially to the nozzle cap bore 5.1 in one direction. A pictorial illustration was dispensed with here; however, it can be deduced analog to FIGS. 4a to 4j and 15a to 15d.

The outer contour AK5 has at least one largest spacing d5 between the longitudinal axis M1 extending through the center of the nozzle cap bore 5.1 of the nozzle cap 5 and the outer contour AK5 which is directed radially to the nozzle cap bore 5.1 in the angular range which is rotated axially to the nozzle cap bore 5.1 to the right or to the left to the virtual connection line of the smallest spacing c5 between the minimum angle βₘᵢₙ of 60° and the maximum angle βₘₐₓ of 120°. The angular range rotated to the right by βₘᵢₙ to βₘₐₓ is shown.

The smallest spacing c5 here amounts by way of example to 12 mm and the largest spacing d5 by way of example to 19 mm. The smallest spacing c5 thus amounts to less than ⅔ of the largest spacing d5.

FIG. 10d shows the view opposite to FIG. 10c of the end of the nozzle cap 5 opposite the nozzle cap tip and the nozzle cap bore 5.1.

The outer contour AK5 of the nozzle cap 5 is not circular/rotationally symmetrical about the longitudinal axis M1.

FIG. 11a to 11d show an arrangement in accordance with the invention having a nozzle cap 5 and a gas passage 7 which can be installed in an arrangement in accordance with FIGS. 7a to 7c and 8a to 8c. FIGS. 11a and 11b show sectional representations of the side views of the nozzle cap 5 which are rotated with respect to one another by 90° about the longitudinal axis M1 extending through the nozzle cap bore 5.1. The nozzle cap 5 has a section tapering conically at the angle γ5, here 100° by way of example, toward the nozzle cap tip in the direction of the nozzle cap bore 5.1.

FIG. 11c shows the view of the nozzle cap tip with the nozzle cap bore 5.1 and the outer contour AK5 of the nozzle cap 5 can be seen. If the nozzle cap 5 is installed in the plasma cutting torch 1, this would be arranged, as shown in FIGS. 7a to 7c and 8a to 8c, in the direction of the plasma torch tip 1.25 behind the nozzle protective cap 8.

A respective exactly one smallest spacing c5 directed radially to the nozzle cap bore 5.1 is observed above and below the nozzle cap bore 5.1. This means that in this example the arrangement has exactly two smallest spacings c5 directed radially to the nozzle cap bore 5.1 between the longitudinal axis M1 extending through the center of the nozzle cap bore 5.1 of the nozzle cap 5 and the outer contour AK5.

An angular range α does not exist in this embodiment or it amounts to 0°. It is, however, also possible that the outer contour AK5 is configured such that the smallest spacing c5 extends in an angular range α of a maximum of 120° or, better, of a maximum of 70°. It is equally possible that the nozzle cap 5 has exactly one smallest spacing c5 directed radially to the nozzle cap bore 5.1 in one direction. A pictorial illustration was dispensed with here; however, it can be deduced from the examples of FIGS. 4a to 4j and 15a to 15d.

The outer contour AK5 has at least one largest spacing d1 between the longitudinal axis M1 extending through the center of the nozzle cap bore 5.1 of the nozzle cap 5 and the outer contour AK5 which is directed radially to the nozzle cap bore 5.1 in the angular range which is rotated axially to the nozzle cap bore 5.1 to the right or to the left to the virtual connection line of the smallest spacing c5 between the minimum angle βₘᵢₙ of 60° and the maximum angle βₘₐₓ of 120°. The angular range rotated to the right by βₘᵢₙ to βₘₐₓ is shown.

The smallest spacing c5 here amounts by way of example to 13 mm and the largest spacing d5 by way of example to 19 mm. The smallest spacing c5 thus amounts to less than ¾ of the largest spacing d5.

FIG. 11d shows the view opposite to FIG. 11c of the end of the nozzle cap 5 opposite the nozzle cap tip and the nozzle cap bore 5.1.

The outer contour AK5 of the nozzle cap 5 is not circular/rotationally symmetrical about the longitudinal axis M1.

FIGS. 12a to 12d show a nozzle protective cap 8 in accordance with the invention which is installed in an arrangement in accordance with FIGS. 7a to 7c. FIGS. 12a and 12b show sectional representations of the side views of the nozzle protective cap 8 which are rotated with respect to one another by 90° about the center line M1 extending through the nozzle cap bore 8.1. The nozzle protective cap 8 has a section tapering conically at the angle γ8, here 100° by way of example, toward the nozzle protective cap tip in the direction of the nozzle protective cap bore 8.1.

FIG. 12c shows the view of the nozzle protective cap tip with the nozzle protective cap bore 8.1 and the outer contour AK8 of the nozzle protective cap 8 can be recognized. If the nozzle protective cap 8 is installed in the plasma cutting torch 1, it would correspond to the plasma torch tip 1.25.

A respective exactly one smallest spacing c8 directed radially to the nozzle protective cap bore 8.1 is observed to the left and right of the nozzle protective cap bore 8.1. This means that in this example in the arrangement exactly two smallest spacings c8 directed radially to the nozzle protective cap bore 8.1 are observed between the longitudinal axis M1 extending through the center of the nozzle protective cap bore 8.1 of the nozzle protective cap 8 and the outer contour AK8.

An angular range α does not exist in this embodiment or it amounts to 0°. It is, however, also possible that the outer contour AK8 is configured such that the smallest spacing c8 extends in an angular range α of a maximum of 120° or, better, of a maximum of 70°. It is equally possible that the nozzle protective cap 8 has exactly one smallest spacing c8 in a direction directed radially to the nozzle cap bore 8.1. A pictorial illustration was dispensed with here; however, it can be deduced from the examples of FIGS. 4a to 4j and 15a to 15d.

The outer contour AK8 has at least one largest spacing d8 between the longitudinal axis M1 extending through the center of the nozzle protective cap bore 8.1 of the nozzle protective cap 8 and the outer contour AK8 which is directed radially to the nozzle protective cap bore 8.1 in the angular range which is rotated axially to the nozzle protective cap bore 8.1 to the right or to the left to the virtual connection line of the smallest spacing c8 between the minimum angle βₘᵢₙ of 60° and the maximum angle βₘₐₓ of 120°. The angular range rotated to the right by βₘᵢₙ to βₘₐₓ is shown.

The smallest spacing c8 here amounts by way of example to 14 mm and the largest spacing d8 by way of example to 19 mm. The smallest spacing c8 thus amounts to less than ¾ of the largest spacing d8.

FIG. 12d shows the view opposite to FIG. 12c of the end of the nozzle protective cap 8 opposite the nozzle protective cap tip and the nozzle protective cap bore 8.1.

The outer contour AK8 of the nozzle protective cap 8 is not circular/rotationally symmetrical.

FIGS. 13a to 13d show an embodiment with a nozzle protective cap holder 9 which can be installed in an arrangement in accordance with FIGS. 8a to 8c. FIGS. 13a and 13b show sectional representations of the side views of the nozzle protective cap holder 9 which are rotated with respect to one another by 90° about the center line M1 extending through the nozzle protective cap holder bore 9.1. The nozzle protective cap holder 9 has a section tapering conically at the angle γ9, here 48° by way of example, toward the nozzle protective cap holder tip in the direction of the nozzle protective cap holder bore 9.1.

FIG. 13c shows the view of the nozzle protective cap holder tip with the nozzle protective cap holder bore 9.1 and the outer contour AK9 of the nozzle protective cap holder 9 can be recognized. If the nozzle protective cap holder 9 is installed in the plasma cutting torch 1, this would be arranged, as shown in FIGS. 8a to 8c, in the direction of the plasma torch tip 1.25 behind the nozzle protective cap 8.

A respective exactly one smallest spacing c9 directed radially to the nozzle protective cap holder bore 9.1 is observed above and below the nozzle protective cap holder bore 9.1. This means that in this example the arrangement has exactly two smallest spacings c9 directed radially to the nozzle protective cap holder bore 9.1 between the longitudinal axis M1 extending through the center of the nozzle protective cap holder bore 9.1 of the nozzle protective cap holder 9 and the outer contour AK9 in two directions.

An angular range α does not exist in this embodiment or it amounts to 0°. It is, however, also possible that the outer contour AK9 is configured such that the smallest spacing c9 extends in an angular range α of a maximum of 120° or, better, of a maximum of 70°. It is equally possible that exactly one smallest spacing c9 directed radially to the nozzle protective cap holder bore 9.1 is observed in one direction at the nozzle protective cap holder 9. A pictorial illustration was dispensed with here; however, it can be deduced from the examples of FIGS. 4a to 4j and FIGS. 15a to 15d.

The outer contour AK9 has at least one largest spacing d9 between the longitudinal axis M1 extending through the center of the nozzle protective cap holder bore 9.1 of the nozzle protective cap holder 9 and the outer contour AK9 which is directed radially to the nozzle protective cap holder bore 9.1 in the angular range which is rotated axially to the nozzle protective cap holder bore 9.1 to the right or to the left to the virtual connection line of the smallest spacing c9 between the minimum angle βₘᵢₙ of 60° and the maximum angle βₘₐₓ of 120°. The angular range rotated to the right by βₘᵢₙ to βₘₐₓ is shown.

The smallest spacing c9 here amounts by way of example to 14 mm and the largest spacing d9 by way of example to 19 mm. The smallest spacing c9 thus amounts to less than ¾ of the largest spacing d9.

FIG. 13d shows the view opposite to FIG. 13c of the end of the nozzle protective cap holder 9 opposite the nozzle protective cap holder tip and the nozzle protective cap holder 9.1.

The outer contour AK9 of the nozzle protective cap holder 9 is not circular/rotationally symmetrical about the longitudinal axis M1.

FIGS. 14a to 14c show an arrangement in accordance with the invention having a nozzle protective cap holder 9 and a nozzle protective cap 8 which can be installed in an arrangement in accordance with FIGS. 8a to 8c. The nozzle protective cap holder 9 is identical to that of the FIGS. 13a to 13c. The nozzle protective cap 8 has a nozzle protective cap bore 8.1 through whose center the longitudinal axis M1 extends. The nozzle protective cap holder 9 has a nozzle protective cap holder bore 9.1 through whose center the longitudinal axis M1 likewise extends. FIGS. 14a and 14b show sectional representations of the side views of the arrangement of nozzle protective cap 8 and nozzle protective cap holder 9 which are rotated with respect to one another by 90° about the longitudinal axis M1 extending through the nozzle protective cap bore 8.1. The nozzle protective cap holder 9 has a section tapering conically at the angle γ9, here 48° by way of example, toward the nozzle protective cap holder tip in the direction of the nozzle protective cap holder bore 9.1.

The nozzle protective cap 8 has a section tapering conically at the angle γ8, here 100° by way of example, toward the nozzle protective cap tip in the direction of the nozzle protective cap bore 8.1.

FIG. 14c shows the view of the nozzle protective cap tip with the nozzle protective cap holder bore 8.1 and the outer contour AK9 of the nozzle protective cap holder 9 can be recognized. If the arrangement with nozzle protective cap 8 and nozzle protective cap holder 9 installed into the plasma cutting torch 1, this would correspond to the plasma torch tip 1.25 as shown in the FIGS. 8a to 8c.

A respective exactly one smallest spacing c9 directed radially to the nozzle protective cap bore 8.1 is observed above and below the nozzle protective cap bore 8.1. This means that in this example the arrangement has exactly two smallest spacings c9 directed radially to the nozzle protective cap bore 8.1 between the longitudinal axis M1 extending through the center of the nozzle protective cap bore 8.1 of the nozzle protective cap 8 and the outer contour AK9.

An angular range α does not exist in this embodiment or it amounts to 0°. It is, however, also possible that the outer contour AK9 is configured such that the smallest spacing c9 extends in an angular range α of a maximum of 120° or, better, of a maximum of 70°. It is equally possible that exactly one smallest spacing c9 directed radially to the nozzle protective cap holder bore 8.1 is observed in one direction in the arrangement with nozzle protective cap holder 8 and nozzle protective cap holder 9. A pictorial illustration was dispensed with here; however, it can be deduced from the examples of FIGS. 4a to 4j.

The outer contour AK9 has at least one largest spacing d9 between the longitudinal axis M1 extending through the center of the nozzle protective cap bore 8.1 of the nozzle protective cap 8 and the outer contour AK8 which is directed radially to the nozzle protective cap holder 8.1 in the angular range which is rotated axially to the nozzle protective cap bore 8.1 to the right or to the left to the virtual connection line of the smallest spacing c9 between the minimum angle βₘᵢₙ of 60° and the maximum angle βₘₐₓ of 120°. The angular range rotated to the right by βₘᵢₙ to βₘₐₓ is shown.

The smallest spacing c9 here amounts by way of example to 14 mm and the largest spacing d9 by way of example to 19 mm. The smallest spacing c9 thus amounts to less than ¾ of the largest spacing d9.

FIG. 14d shows the view opposite to FIG. 14c of the end of the nozzle protective cap holder 9 opposite the tip of the arrangement of nozzle protective cap 8 and nozzle protective cap holder 9 and the nozzle protective cap bore 8.1.

The outer contour AK9 of the arrangement of nozzle protective cap holder 9 and nozzle protective cap 8 is not circular/rotationally symmetrical.

FIGS. 15a to 15d show different embodiments of plasma torch wear parts in accordance with the invention with a view of the plasma torch tip 1.25.

The nozzle protective cap is shown by way of example here in FIGS. 15a and 15c.

An arrangement of nozzle protective cap 8 and nozzle protective cap holder 9 is shown in FIGS. 15b and 15d.

In this respect, the smallest spacings c as well as the largest spacings d are indicated by way of example. Examples are shown in FIGS. 15a and 15b in which there are a plurality of angular ranges a in which the smallest spacings c are observed. The angular range α amounts to 67° in FIGS. 4a and 4b. A second angular range α of exactly the same size is present below the nozzle protective cap bore 8.1 in addition to the angular range α shown above the nozzle protective cap bore 8.1. This angular range is not shown for purposes of clarity, but can be deduced from the observation of FIGS. 2c and 2d.

The angular range α is only present above the nozzle protective cap bore 8.1 in FIGS. 15c and 15d, while exactly one smallest spacing c (not shown) is observed, but no angular range α is present, below the nozzle bore.

Asymmetrical embodiments are equally shown by way of example in FIGS. 15c and 15d.

FIGS. 16a to 16d show different views of a schematic arrangement respectively having two plasma cutting torches 1.1 and 1.2 in accordance with the invention. The plasma cutting torches cut a workpiece 20 having a thickness t. A representation of the plasma jets exiting the nozzle bores was omitted since their direction corresponds to the longitudinal axes M1 and M2 exiting the nozzle bores.

It is in this respect the plasma cutting torches 1 shown in FIGS. 3a to 3d and the arrangement in accordance with the example shown in FIGS. 6a to 6c. The plasma cutting torches are arranged with respect to one another at the respective side at which a smallest spacing c is observed. They are therefore here arranged with respect to one another at the side which is flat by way of example. They so-to-say stand transversely to the feed direction v and the kerfs F1, F2 and F3 which are formed. It is thus possible to arrange the longitudinal axes M1 and M2 guided through the centers of the nozzle bores 4.1 of the respective nozzle with a spacing from one another which is as small as possible. This has the advantage with respect to plasma cutting torches in accordance with the prior art that the spacing of the plasma jets with respect to one another exiting the respective nozzle bore of the two plasma cutting torches can be kept small and all the elements required for operation can be accommodated. A small spacing is in particular of advantage due to the higher accuracy of the created contour in the cutting of contours such as here with two or three plasma cutting torches simultaneously, in particular in the cutting of edges, circles and non-linear shapes. Since the arrangement in accordance with FIGS. 6a to 6c, and thus also the nozzle cap 5 in accordance with FIGS. 10a to 10c, is used in the plasma cutting torches shown by way of example in which the smallest spacing c is equal to 12 mm, the spacing z1 which is observed between the longitudinal axes M1 and M2 can amount to only 25 mm. A minimal spacing z11 of 1 mm can then be observed here between the outer contours of both plasma cutting torches.

It is furthermore shown in FIGS. 16a to 16d that the longitudinal axes M1 and M2, and thus the plasma cutting torches 1.1 and 1.2 are inclined by the angle 61 with respect to one another. The angular range can be selected from 0 to 60° in both directions.

This is required for the cutting of chamfers for the weld seam preparation which are required for the different angles of the cutting edges produced during cutting. Examples for this are explained inter alia in DIN EN ISO 9692-2. The cutting of a so-called Y seam is shown in FIG. 16b. In this respect, the kerf F1 having the width f1 and then the oblique kerf F2 having the width f2 are cut by the plasma cutting torch 1.1 arranged almost perpendicular to the workpiece 20. The result is then, as the right part of the workpiece 20 in FIG. 16b shows, a cutting edge having a perpendicular web t1 and an obliquely inclined flank or chamfer t2 of the cutting edge.

The cutting of such chamfers is only meaningful from a workpiece thickness of 10 mm onward and can also amount to 50 mm depending on the application. The material thickness which a suitable plasma cutting torch can cut is considerably larger in dependence on the angle 61 and can amount to 1.5 fold, that is 15 mm or also 75 mm. The electric current during plasma cutting with which such material thicknesses can be cut productively amounts to at least 200 A. The nozzle bores 4.1 of the nozzles 4 then have a diameter of at least 1.7 mm, better 2.0 mm up to 2.4 mm. For larger material thicknesses, cutting takes place with higher currents, e.g. 400 A, and also larger diameters of the nozzle bores, e.g. having with diameters larger than 3 mm. The plasma cutting torches and their construction shapes therefore have to be suitable to be able to transmit such electric currents reliably and simultaneously to be able to be arranged as closely as possible next to one another to achieve a contour accuracy which is as high as possible of the desired shape of the workpiece to be cut during cutting. At least one wear part of such plasma cutting torches, in particular the electrode 2, the nozzle 4 and/or the nozzle cap 5, can, as already shown in FIGS. 5a to 8c, be liquid-cooled.

Plasma cutting torches in accordance with the prior art have a circular outer contour having a diameter of 50 mm in this current range, as shown in FIGS. 1a to 1c, and can thus not be arranged so closely next to one another as the plasma cutting torches used in the invention.

At least one virtual connection line of at least one smallest spacing c, which is observed between the outer contour AK and the longitudinal axis M1 extending through the center of the nozzle bore 4.1 of the nozzle 4, which is inclined from the axis feed direction v of the plasma cutting torch with respect to the workpiece 20 by an angle E of a maximum of 30°, preferably a maximum of 15°, particularly preferably of a maximum of 5°, and very particularly preferably is aligned parallel therewith. This is shown in FIG. 16d and FIG. 17d.

FIGS. 17a to 17d show different views of an arrangement having three plasma cutting torches 1.1, 1.2 and 1.3 in accordance with the invention. The plasma cutting torches cut a workpiece 20 having a thickness t. A representation of the plasma jets exiting the nozzle bores was omitted since their direction corresponds to the longitudinal axes M1, M2 and M3 exiting the nozzle bores.

It is in this respect the plasma cutting torches 3 shown in FIGS. 3a to 3d and the arrangement in accordance with the example shown in FIGS. 6a to 6c. The plasma cutting torches 1.1, 1.2 and 1.3 are arranged with respect to one another at the respective side at which a smallest spacing c is observed. They are therefore here arranged, aligned facing one another at the side, which is flat by way of example. They are so-to-say transversely aligned to the axial feed direction v and the kerfs F1, F2 and F3 which are formed. It is thus possible to arrange the longitudinal axes M1, M2 and M3 guided through the centers of the nozzle bores 4.1 of the respective nozzle as closely as possible next to one another. This has the advantage with respect to plasma cutting torches in accordance with the prior art that the spacing of the plasma jets exiting through the respective nozzle bore of the two plasma cutting torches can be small with respect to one another. A small spacing is in particular of advantage due to the higher accuracy of the created contour in the cutting of contours such as here with three plasma cutting torches simultaneously, in particular in the cutting of edges, circles and non-linear shapes. Since the arrangement in accordance with FIGS. 6a to 6c, and thus also the nozzle cap 5 in accordance with FIGS. 10a to 10c, can be used in the plasma cutting torches 1.1, 1.2 and 1.3 shown by way of example in which the smallest spacing c is 12 mm, the spacing z1 which has to be observed between the longitudinal axes M1 and M2 and the spacing z2 which has to be observed between the longitudinal axes M1 and M3 can each amount to 25 mm. A minimal spacing z11 and z12 of 1 mm can then be reached here between the outer contours AK between the plasma cutting torches 1.1 and 1.2 as well as 1.1 and 1.3. The minimal spacing between the longitudinal axes M2 and M3 of the plasma cutting torches 1.3 and 1.2 thus only amounts to 50 mm.

It is furthermore shown in FIGS. 17a to 17d that the longitudinal axes M1 and M2, and thus the plasma cutting torches 1.1 and 1.2, can be inclined with respect to one another by the angle 61 and the longitudinal axes M1 and M3, and thus the plasma cutting torches 1.1 and 1.3, about the angle 62. The angular range for the angles δ1 and δ2 can amount from 0 to 60° in both directions.

This is required for the cutting of chamfers for the weld seam preparation for which the different angles of the cutting edges produced during cutting are required. Examples for this are explained inter alia in DIN EN ISO 9692-2. The cutting of a so-called DY seam is shown in FIG. 17b. In this respect, the oblique kerf F3 having the width f3 is formed by the plasma cutting torch 1.3 inclined obliquely by the angle 62 with respect to the plasma cutting torch 1.1.

The kerf F1 having the width f1 is formed by the plasma cutting torch 1.1 arranged almost perpendicular to the workpiece and the oblique kerf F2 having the width f2 is formed by the plasma cutting torch 1.2 inclined by the angle δ1. This result is then, as the right part of the workpiece 20 in FIG. 16b shows, a cutting edge (in accordance with EN ISO 9692-2) having a perpendicular web t1, an upper flank or chamfer t2 and a lower oblique flank or chamfer t3.

The cutting of these chamfers is only meaningful from a workpiece thickness t of 16 mm onward and can also amount to 50 mm depending on the application. The material thickness which the inclined plasma cutting torch has to be cut is much larger in dependence on the angles 61 and 62 and can amount to 1.5-fold, that is 24 mm to 75 mm. The electric current in plasma cutting at which such material thicknesses can be cut productively amounts to at least 200 A; the nozzle bores 4.1 of the nozzles 4 then have a diameter of at least 1.7 mm, better 2.0 mm up to 2.4 mm. For larger material thicknesses, cutting takes place with higher electrical currents, e.g. 400 A, and also larger diameters of the nozzle bores, e.g. with diameters larger than 3 mm. The plasma cutting torches and their construction shapes therefore should be suitable to be able to transmit such electrical currents reliably and simultaneously to be able to be arranged as closely as possible next to one another to achieve a contour accuracy which is as high as possible of the desired shape of the workpiece to be cut during cutting.

At least one wear part of such plasma cutting torches, in particular the electrode 2, the nozzle 4 and/or the nozzle cap 5, are, as already shown in FIGS. 5a to 8c, liquid-cooled.

Plasma cutting torches in accordance with the prior art have a circular outer contour having a diameter of 50 mm in this electrical current range, as shown in FIGS. 1a to 1c, and can thus not be arranged so closely next to one another as the plasma cutting torches in accordance with the invention without deviations from the desired contour to be cut or quality losses arising.

1. A plasma cutting torch arrangement having at least one plasma cutting torch (1.1, 1.2, 1.3) which is formed by a torch body (1.10), an electrode (2) and a nozzle (4) having a nozzle bore (4.1), wherein an outer contour (AK) of the plasma cutting torch (1.1, 1.2, 1.3) is present in cross-section with respect to a longitudinal axis (M1, M2, M3) which is aligned perpendicular through the nozzle bore (4.1),
characterized in that
a smallest spacing (c) between the longitudinal axis (M1, M2, M3) extending through the center of the nozzle bore (4.1) of the nozzle (4) and the radially outer margin of the outer contour (AK) is observed in at least one axial direction and corresponds at a maximum to ¾ of the length of a largest spacing (d) between the central longitudinal axis (M1, M2, M3) extending through the center of the nozzle bore (4.1) of the nozzle (4) and the radial outer margin of the outer contour (AK); or
the smallest spacing (c) corresponds to a maximum of ⅜ of the length of a largest spacing (b) between two points of the outer margin of the outer contour (AK) whose virtual straight connection line extends through the central longitudinal axis (M1, M2, M3) extending through the center of the nozzle bore (4.1) of the nozzle (4).

2. An arrangement in accordance with claim 1, characterized in that a smallest spacing (c) in two opposite directions is observed along a common axis which is guided, starting from the longitudinal axis (M1, M2, M3) extending through the center of the nozzle bore (4.1) of the nozzle (4), up to the radially outer margin of the outer contour (AK).

3. An arrangement in accordance with claim 1, characterized in that at least one smallest spacing (c) is observed over the total length of a plasma cutting torch (1.1, 1.2, 1.3).

4. An arrangement in accordance with claim 1, characterized in that a smallest spacing (c) is observed over the total length of the nozzle (4), the nozzle cap (5), a nozzle protective cap (8) or a nozzle protective cap holder (9).

5. An arrangement in accordance with claim 1, characterized in that a smallest spacing (c) is observed over at least a length (l) which corresponds to at least 1.4-fold the maximum width of a plasma cutting torch (1.1, 1.2, 1.3) in the region in which a smallest spacing (c) is observed.

6. An arrangement in accordance with claim 1, characterized in that the center of the nozzle bore (4.1) is arranged eccentrically within the outer contour (AK).

7. An arrangement in accordance with claim 1, characterized in that a smallest spacing (c) is observed of a maximum of ⅓, preferably of a maximum of ¼, and particularly preferably of a maximum of ⅙ of the largest spacing (b); or
in that a smallest spacing (c) is observed of a maximum of ⅔, preferably of a maximum of ½, and particularly preferably of a maximum of ⅓ of the largest spacing (d).

8. An arrangement in accordance with claim 1, characterized in that a smallest spacing (c) starting about the longitudinal axis (M1, M2, M3) is observed in at least one angular range α of a maximum of 120°, preferably of a maximum of 70°.

9. An arrangement in accordance with claim 1, characterized in that the outer contour (AK) has at least one largest spacing (d) which is directed radially to the nozzle bore (4.1) between two points of the largest spacing (b) of the outer contour (AK) whose virtual straight connection line intersects the virtual longitudinal axis (M1, M2, M3) extending through the center of the nozzle bore (4.1) of the nozzle (4) in the angular range which is rotated axially to the nozzle bore (4.1) to the right or left to the virtual connection line of the smallest spacing (c) or to the virtual connection line which is arranged at half the angular range α of the smallest spacing (c) between a minimal angle βₘᵢₙ of 60° and the maximum angle of βₘₐₓ of 120°; or
has at least one largest spacing (b), directed radially to the nozzle bore (4.1), between the longitudinal axis (M1, M2, M3) extending through the center of the nozzle bore (4.1) of the nozzle (4) and the radially outer margin of the outer contour (AK).

10. An arrangement in accordance with claim 1, characterized in that a smallest spacing (c) is observed of a maximum of 20 mm, preferably of a maximum of 15 mm and particularly preferably of a maximum of 12.5 mm.

11. An arrangement in accordance with claim 1, characterized in that the outer contour (AK) has a circular, polygonal, a curved, a semicircular, an oval or an elliptical shape or a combination thereof.

12. An arrangement in accordance with claim 1, characterized in that at least one smallest spacing (c) of an outer contour (AK) is observed at a plasma torch (1.1) in the direction of at least one further plasma torch (1.2, 1.3) operated next to the plasma torch (1.1).

13. An arrangement in accordance with claim 12, characterized in that a maximum spacing z1, z2 is observed between virtually extended longitudinal axes (M1.1, M1.2, M1.3) of the respective nozzle bores (4.1) of the nozzles (4) of plasma cutting torches (1.1, 1.2, 1.3) arranged next to one another of 42 mm, advantageously 32 mm, and particularly advantageously 27 mm.

14. An arrangement in accordance with claim 1, characterized in that at least one virtual connection line of at least one smallest spacing (c), which is observed between the outer contour AK and the longitudinal axis (M1) extending through the center of the nozzle bore (4.1) of the nozzle (4), which is inclined from the axis feed direction (v) of the plasma cutting torch (1.1, 1.2, 1.3) with respect to the workpiece (20) by an angle E of a maximum of 30°, preferably a maximum of 15°, particularly preferably of a maximum of 5°, and very particularly preferably is aligned parallel therewith.

15. Use of wear parts in an arrangement in accordance with claim 1, wherein in at least one of the plasma cutting torches (1.1, 1.2, 1.3) a nozzle (4) or a nozzle cap (5) or a nozzle protective cap (8) or a nozzle protective cap holder (9) are in particular present as wear parts which have an outer contour (AK) which satisfies the conditions of claim 1.
